(19) United States
(12) Patent Application Publication
(10) Pub. No.: US 2026/0168123 A1
(43) Pub. Date: Jun. 18, 2026

(54) METHODS AND COMPOSITIONS FOR ELECTRODEPOSITION

(71) Applicant: Curium US LLC, St. Louis, MO (US)

(72) Inventors: Brian Regna, St. Louis, MO (US); Lars Lindskob, St. Louis, MO (US); Allan Casciola, St. Louis, MO (US); Jeffrey Randick, St. Louis, MO (US)

(21) Appl. No.: 19/419,876

(22) Filed: Dec. 15, 2025

Related U.S. Application Data
(60) Provisional application No. 63/733,867, filed on Dec. 13, 2024.

(51) Int. Cl. C25D 3/12; G21G 1/00

(52) U.S. Cl. CPC C25D 3/12; G21G 1/001; G21G 2001/0094

(57) ABSTRACT

The present disclosure is directed to methods for electrodepositing nickel-64 (Ni-64) onto one or more targets for subsequent radionuclide production. The plated targets may be irradiated to produce radionuclides such as Cu-64 and Co-61 for use in positron-emission tomography (PET). The disclosed methods provide improved plating efficiency, deposit quality, and material utilization for Ni-64 target preparation.

### CROSS-REFERENCE TO RELATED APPLICATIONS

The present application claims the benefit under 35 U.S.C. § 119 of and priority to U.S. Provisional Patent Application No. 63/733,867, filed Dec. 13, 2024, and titled “SUMMARY OF NICKEL PLATING BATH DEPLETION DEVELOPMENT,” the contents of which is incorporated herein by reference in its entirety for all purposes.

### BACKGROUND

To expand radioisotope production capacity, cyclotron platforms may be developed and used to increase the yield of radionuclides. Scaling production to a higher-energy or higher-current cyclotron often requires modifications to existing targetry, including changes to the geometry, materials, and mounting configuration of the metallic precursor targets. In particular, when transitioning to target systems such as TR-30-type assemblies from CS-30 target assembles, it becomes necessary to redevelop methods for depositing enriched nickel-64 onto the target backing.

Conventional plating cells and bath formulations used for small-scale or legacy systems are not always suitable for the thermal, geometric, or operational constraints associated with next-generation cyclotrons. As a result, new plating cell designs and optimized electrodeposition conditions must be developed to ensure uniform deposition, high adhesion, efficient use of enriched ⁶⁴Ni, and compatibility with the increased beam currents used during scale-up. These efforts include investigation of alternative plating bath chemistries, electrode configurations, and process parameters tailored for reliable and reproducible target preparation under the new operating conditions.

Prior plating methods used for CS-30 or legacy cyclotrons could not achieve full depletion of Ni-64 from solution, often leaving 30-100 mg Ni-64 unused, producing darker oxide-rich deposits, and exhibiting inferior adhesion under bombardment. There was a need for a method capable of reproducibly depositing substantially all Ni-64 from solution while producing uniform, adherent layers compatible with high-current TR-30 cyclotron irradiation.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

The present disclosure relates to methods for electrodepositing nickel-64 (Ni-64) onto one or more target plates for subsequent radionuclide production. In certain embodiments, the method may include preparing a Ni-64 plating bath having an initial Ni-64 concentration selected based on a desired plated mass of Ni-64, introducing the plating bath into an electroplating cell comprising one or more targets and an anode, and electrodepositing Ni-64 onto the targets until at least 99% of the initial Ni-64 concentration in the bath is depleted. Following deposition, the plated targets may be removed from the electroplating cell. The plated targets produced by the method may subsequently be bombarded to generate Cu-64 and Co-61 radionuclides useful in positron-emission tomography (PET) and other nuclear medicine applications.

The methods disclosed herein may further include evaluating the adhesion of the deposited Ni-64 layer by applying and removing tape from the plated surface, where acceptable deposits exhibit no visible removal of Ni-64 during the adhesion test. In various embodiments, the electroplating cell may be configured to hold a single target, a double-target assembly, or a triple-target assembly. The use of a triple-target assembly may provide improved deposit uniformity and reduced residual Ni-64 remaining in solution compared to single- or double-target configurations.

In certain embodiments, electrodeposition may be continued until at least 99.5%, 99.9%, 99.95%, or 99.99% of the initial Ni-64 concentration is depleted. The electrodeposition current may range from about 200 mA to about 500 mA, and the deposition duration may range from about 60 minutes to about 420 minutes, including sub-ranges such as about 60 minutes to about 120 minutes, about 120 minutes to about 150 minutes, about 120 minutes to about 180 minutes, about 180 minutes to about 240 minutes, about 240 minutes to about 300 minutes, about 300 minutes to about 360 minutes, and about 360 minutes to about 420 minutes. In some embodiments, the method may employ specific current sub-ranges, including about 200 mA to about 250 mA, about 250 mA to about 300 mA, about 300 mA to about 350 mA, about 350 mA to about 400 mA, about 400 mA to about 450 mA, or about 450 mA to about 500 mA. In further embodiments, the targeted plated mass of Ni-64 per target may range from about 400 mg to about 800 mg.

### BRIEF DESCRIPTION OF THE FIGURES

Various features, aspects, and advantages of the present disclosure will become better understood when the following detailed description is read with reference to the accompanying figures in which like characters represent like parts throughout the figures, wherein:

FIG. 1 is a graph illustrating an exemplary excitation function showing the cross section for the ⁶⁴Ni(p,n)⁶⁴Cu reaction as a function of incident proton energy.

FIG. 2 is a graph illustrating an exemplary excitation function showing the cross section for the ⁶⁴Ni(p,n)⁶⁴Cu reaction as a function of proton energy.

FIG. 3 is a process flow diagram illustrating an exemplary workflow for preparing a Ni-64 plating solution for electrodeposition according to some embodiments of the present disclosure.

FIG. 4 is a process flow diagram illustrating an exemplary workflow for preparing a Ni-64 plating solution for electrodeposition according to some embodiments of the present disclosure.

FIG. 5 is a process flow diagram illustrating an exemplary workflow for preparation of Ni-64 targets and an electroplating cell, followed by electrodeposition of Ni-64 onto the targets according to some embodiments of the present disclosure.

FIG. 6A is a photograph of representative Ni-64 deposits obtained from electrodeposition onto a single target, following an adhesion test using a tape pull according to some embodiments of the present disclosure.

FIG. 6B is a photograph of representative Ni-64 deposits obtained from electrodeposition onto a double-target assembly, following an adhesion test using a tape pull according to some embodiments of the present disclosure.

FIG. 6C is a photograph of representative Ni-64 deposits obtained from electrodeposition onto a triple-target assembly, following an adhesion test using a tape pull according to some embodiments of the present disclosure.

FIG. 7 is a graphical representation illustrating the depletion of Ni-64 from the plating bath during electrodeposition at three different applied currents—500 mA, 350 mA, and 200 mA, according to some embodiments of the present disclosure

FIG. 8A is a photograph of a target illustrating Ni-64 deposits obtained after electrodeposition at 500 mA using deposition times sufficient to achieve ≥99% Ni-64 depletion for each condition according to some embodiments of the present disclosure.

FIG. 8B is a photograph of a target illustrating Ni-64 deposits obtained after electrodeposition at 350 mA using deposition times sufficient to achieve ≥99% Ni-64 depletion for each condition according to some embodiments of the present disclosure.

FIG. 8C is a photograph of a target illustrating Ni-64 deposits obtained after electrodeposition at 200 mA using deposition times sufficient to achieve ≥99% Ni-64 depletion for each condition according to some embodiments of the present disclosure.

FIG. 9 is a photograph of triple target deposition at 500 mA for 120 minutes with a starting concentration of Ni at 750 mg per target according to some embodiments of the present disclosure.

FIG. 10A is a photograph of a target plate showing surface appearance and coating consistency after the initial Ni deposition according to some embodiments of the present disclosure.

FIG. 10B is a photograph of a target plate showing surface appearance and coating consistency after a Ni-free deposition run according to some embodiments of the present disclosure.

FIG. 10C is a photograph of a target plate showing surface appearance and coating consistency after deposition of 100 mg of Ni according to some embodiments of the present disclosure.

FIG. 11 is a photograph of triple-plated targets deposited at 1500 mA for 120 min with a starting concentration of Ni at 750 mg per target according to some embodiments of the present disclosure.

FIG. 12 is a photograph of triple-plated targets deposited at 500 mA for 120 min with a starting concentration of Ni at 400 mg per target according to some embodiments of the present disclosure.

FIG. 13 is a photograph of triple-plated targets deposited at 200 mA for 180 min with a starting concentration of Ni at 400 mg per target according to some embodiments of the present disclosure.

FIG. 14 is a photograph of triple-plated targets deposited at 500 mA for 75 min with a starting concentration of Ni at 400 mg per target according to some embodiments of the present disclosure.

FIG. 15 is a photograph of triple-plated targets deposited at 200 mA for 300 min with a starting concentration of Ni at 750 mg per target according to some embodiments of the present disclosure.

FIG. 16A is a photograph of triple-plated targets deposited at 500 mA for 120-150 min with a starting concentration of Ni of 25 mg/mL at 750 mg per target according to some embodiments of the present disclosure.

FIG. 16B is a photograph of triple-plated targets deposited at 500 mA for 120 min with a starting concentration of Ni of 21.7 mg/mL at 650 mg per target according to some embodiments of the present disclosure.

FIG. 16C is a photograph of triple-plated targets deposited at 250 mA for 180 min with a starting concentration of Ni of 18.3 mg/mL at 550 mg per target according to some embodiments of the present disclosure.

FIG. 16D is a photograph of triple-plated targets deposited at 200 mA for 200 min with a starting concentration of Ni of 13.3 mg/mL at 400 mg per target according to some embodiments of the present disclosure.

FIG. 17 is a photograph of triple-plated targets deposited at 350 mA for 180 min with a starting concentration of Ni at 400 mg per target according to some embodiments of the present disclosure.

FIG. 18A is a photograph of triple-plated targets in a Flip Cell deposited at 500 mA for 120-150 min with a starting concentration of Ni of 25 mg/mL at 750 mg per target according to some embodiments of the present disclosure.

FIG. 18B is a photograph of triple-plated targets in a Flip Cell deposited at 500 mA for 120 min with a starting concentration of Ni of 21.7 mg/mL at 650 mg per target according to some embodiments of the present disclosure.

FIG. 18C is a photograph of triple-plated targets deposited in a Flip Cell at 250 mA for 180 min with a starting concentration of Ni of 18.3 mg/mL at 550 mg per target according to some embodiments of the present disclosure.

FIG. 18D is a photograph of triple-plated targets deposited in a Flip Cell at 200 mA for 200 min with a starting concentration of Ni of 13.3 mg/mL at 400 mg per target according to some embodiments of the present disclosure.

FIG. 19 is a photograph of triple-plated targets deposited in a Flip Cell at 500 mA with a starting concentration of Ni at 750 mg per target, but with an increased volume of 60 mL from the original 30 mL, according to some embodiments of the present disclosure.

FIG. 20 is a photograph of triple-plated targets according to some embodiments of the present disclosure.

FIG. 21 is a photograph of triple-plated targets according to some embodiments of the present disclosure.

FIG. 22 is a photograph of triple-plated targets according to some embodiments of the present disclosure.

FIG. 23 is a photograph of triple-plated targets according to some embodiments of the present disclosure.

### DETAILED DESCRIPTION

The present disclosure is directed to a method of electrodepositing nickel-64 (Ni-64) onto one or more targets for subsequent irradiation and radionuclide production. The methods described herein enable efficient, reproducible, and high-yield deposition of enriched Ni-64 from an aqueous plating bath onto conductive target substrates, while minimizing material loss and ensuring uniform adhesion suitable for high-power cyclotron operation. The present disclosure is also directed to an electrodeposited plate.

### Method of Electrodepositing

The present disclosure provides methods for electrodepositing nickel-64 (Ni-64) onto one or more target substrates. The one or more plated targets may be subsequently bombarded to produce ⁶⁴Cu/Cu-64 and ⁶¹Co/Co-61 radionuclides for use in positron-emission tomography (PET).

The method of electrodepositing Ni-64 onto one or more targets may include preparing a Ni-64 plating bath in which the initial Ni-64 concentration may be selected based on the desired plated mass of Ni-64. The prepared plating bath may be introduced into an electroplating cell that comprises the one or more targets and an anode. During operation, an electrical current may be applied to electrodeposit Ni-64 from the plating bath onto the targets until at least 99% of the initial Ni-64 concentration in the bath has been depleted, thereby forming one or more plated targets. Following completion of the electrodeposition process, the plated targets may be removed from the electroplating cell for subsequent processing or use.

The method may further include evaluating the integrity of the deposited Ni-64 layer by performing an adhesion test on a plated surface of the one or more plated targets. The adhesion test may involve applying an adhesive tape to the plated surface and subsequently removing the tape under controlled conditions to assess whether any portion of the deposited Ni-64 detaches from the target.

### i) Ni-64 Plating Bath

The method may include preparing a Ni-64 plating bath. The plating bath may be an aqueous solution containing soluble Ni-64 salt, an acid, and a base. Soluble Ni-64 salt, acid, base, and water may be mixed until a homogenous solution is formed. The pH of the Ni-64 plating bath may be adjusted to fall within a range suitable for stable solubility of Ni-64 ions and predictable electrochemical deposition behavior.

The soluble Ni-64 salt includes but is not limited to Ni-64 nitrate, Ni-64 chloride, or Ni-64 sulfate. The soluble Ni-64 salt may be a virgin soluble Ni-64 salt, a recovered soluble Ni-64 salt, or both.

The acid may be a weak, non-oxidizing acid capable of stabilizing pH or metal-ion activity during electrodeposition. The acid may include boric acid, carbonic acid, phosphoric acid, phosphorous acid, silicic acid, metaboric acid, citric acid, lactic acid, acetic acid, formic acid, gluconic acid, malic acid, and tartaric acid, as well as mixtures thereof. The acid may function to maintain bath stability, buffer the local cathodic environment, and improve deposit quality during Ni-64 electrodeposition.

The base may be a weak, water-soluble base capable of adjusting or maintaining the pH of the plating solution without destabilizing the dissolved Ni-64 species. Suitable bases include, but are not limited to, alkali metal carbonates (e.g., sodium carbonate, potassium carbonate), alkali metal bicarbonates (e.g., sodium bicarbonate, potassium bicarbonate), alkali metal phosphates, alkali metal borates, alkali metal silicates, magnesium hydroxide, calcium hydroxide, weak organic bases such as triethanolamine, monoethanolamine, diethanolamine, pyridine, and tris(hydroxymethyl)aminomethane (TRIS), and ammonium salts (e.g. ammonium hydroxide, ammonium carbonate, ammonium bicarbonate, or ammonium acetate). The bases may function to regulate solution pH, promote bath stability, and improve Ni-64 deposition characteristics.

The water may be high-resistivity water (HRW).

In certain implementations, the bath further includes one or more additives such as buffering agents, complexants, surfactants, or wetting agents to promote smooth, adherent, and uniform deposition, though additives are optional.

In some embodiments, the soluble Ni-64 salt may be nickel chloride (⁶⁴NiCl₂). In some embodiments, the nickel chloride may be virgin nickel chloride, recovered nickel chloride, or a mixture of virgin nickel chloride and recovered nickel chloride.

In some embodiments, the acid may be boric acid. In some embodiments, the base may be ammonium hydroxide.

The concentration of Ni-64 in the plating bath may be selected based on the desired final plated mass of Ni-64 on the targets. For example, the initial Ni-64 concentration may be selected to deposit a mass sufficient to support optimized Cu-64 production for a specified beam current, target geometry, or irradiation time.

The targeted plated mass of Ni-64 may be between about 400 mg to about 800 mg per target plate. The mass may be between about 410 mg to about 790 mg, about 420 mg to about 780 mg, about 430 mg to about 770 mg, about 440 mg to about 760 mg, about 450 mg to about 750 mg, about 460 mg to about 740 mg, about 470 mg to about 730 mg, about 480 mg to about 720 mg, about 490 mg to about 710 mg, about 500 mg to about 700 mg, about 510 mg to about 690 mg, about 520 mg to about 680 mg, about 530 mg to about 670 mg, about 540 mg to about 660 mg, about 550 mg to about 650 mg, about 560 mg to about 640 mg, about 570 mg to about 630 mg, about 580 mg to about 620 mg, or about 590 mg to about 610 mg per target plate. In some embodiments, the targeted plated mass of Ni-64 may be between about 400 mg to about 450 mg, about 450 mg to about 500 mg, about 500 mg to about 550 mg, about 550 mg to about 600 mg, about 600 mg to about 650 mg, about 650 mg to about 700 mg, about 700 mg to about 750 mg, or about 750 mg to about 800 mg per target plate.

The plating bath may include Ni-64 in an amount from about 100 mg to about 3000 mg to plate about 400 mg to about 800 mg of Ni-64 per target plate. For example, the amount may be from about 200 mg to about 2900 mg, about 300 mg to about 2800 mg, about 400 mg to about 2700 mg, about 500 mg to about 2600 mg, about 600 mg to about 2500 mg, about 700 mg to about 2400 mg, about 800 mg to about 2300 mg, about 900 mg to about 2200 mg, about 1000 mg to about 2100 mg, about 1100 mg to about 2000 mg, about 1200 mg to about 1900 mg, about 1300 mg to about 1800 mg, about 1400 mg to about 1700 mg, about 1500 mg to about 1600 mg, about 1100 mg to about 2000 mg, about 1200 mg to about 1900 mg, about 1300 mg to about 1800 mg, about 1400 mg to about 1700 mg, about 1500 mg to about 1600 mg, about 1250 mg to about 2350 mg, about 1350 mg to about 2250 mg, about 1450 mg to about 2150 mg, or about 1550 mg to about 2050 mg to plate about 400 mg to about 800 mg of Ni-64 per target. In some embodiments, the amount of Ni-64 may be from about 1350 mg to about 2250 mg, to plate about 400 mg to about 800 mg of Ni-64 per target plate. In some embodiments, the amount of Ni-64 may be about 1800 mg to plate about 400 mg to about 800 mg of Ni-64 per target plate.

The plating bath may include boric acid in an amount of about 0 g to about 5 g to plate about to plate about 400 mg to about 800 mg of Ni-64 per target plate. The amount of boric acid may be from about 0.1 g to about 4.9 g, about 0.2 g to about 4.8 g, about 0.3 g to about 4.7 g, about 0.4 g to about 4.6 g, about 0.5 g to about 4.5 g, about 0.6 g to about 4.4 g, about 0.7 g to about 4.3 g, about 0.8 g to about 4.2 g, about 0.9 g to about 4.1 g, 1.0 g to about 4.0 g, about 1.1 g to about 3.9 g, about 1.2 g to about 3.8 g, about 1.3 g to about 3.7 g, about 1.4 g to about 3.6 g, about 1.5 g to about 3.5 g, about 1.6 g to about 3.4 g, about 1.7 g to about 3.3 g, about 1.8 g to about 3.2 g, about 1.9 g to about 3.1 g, 2.0 g to about 3.0 g, about 2.1 g to about 2.9 g, about 2.2 g to about 2.8 g, about 2.3 g to about 2.7 g, or about 2.4 g to about 2.6 g to plate about 400 mg to about 800 mg Ni-64 per target plate. In some embodiments, the amount of boric acid may be from about 0 g to about 4.5 g to plate about 400 mg to about 800 mg Ni-64 per target plate. In some embodiments, the amount of boric acid may be about 2.7 g to plate about 400 mg to about 800 mg Ni-64 per target plate.

The ammonium hydroxide may be formed by reacting ammonia with water. The percent of ammonium hydroxide in water may be from about 20% to about 40% by weight of the solution to plate about 400 mg to about 800 mg Ni-64 per target plate. The percent of ammonium hydroxide in water may be about 20%, about 20.5%, about 21%, about 21.5%, about 22%, about 22.5%, about 23%, about 23.5%, about 24%, about 24.5%, about 25%, about 25.5%, about 26%, about 26.5%, about 27%, about 27.5%, about 28%, about 28.5%, about 29%, about 29.5%, about 30%, about 30.5%, about 31%, about 31.5%, about 32%, about 32.5%, about 33%, about 33.5%, about 34%, about 34.5%, about 35%, about 35.5%, about 36%, about 36.5%, about 37%, about 37.5%, about 38%, about 38.5%, about 39%, or about 40.5% by weight of the solution to plate about 400 mg to about 800 mg Ni-64 per target plate. In some embodiments, the percent may be about 28% to about 30% by weight of the solution to plate about 400 mg to about 800 mg Ni-64 per target plate. The plating bath may include ammonium hydroxide in an amount of about 10 mL to about 40 mL to plate about 400 mg to about 800 mg Ni-64 per target plate. The amount of ammonium hydroxide may be from about 11 mL to about 39 mL, about 12 mL to about 38 mL, about 13 mL to about 37 mL, about 14 mL to about 36 mL, about 15 mL to about 35 mL, about 16 mL to about 34 mL, about 17 mL to about 33 mL, about 18 mL to about 32 mL, about 19 mL to about 31 mL, about 20 mL to about 30 mL, about 21 mL to about 29 mL, about 22 mL to about 28 mL, about 23 mL to about 27 mL, or about 24 mL to about 26 mL to plate about 400 mg to about 800 mg Ni-64 per target plate. In some embodiments, the amount of ammonium hydroxide may be from about 29 mL to about 31 mL to plate about 400 mg to about 800 mg Ni-64 per target plate. In some embodiments, the amount of ammonium hydroxide may be about 30 mL to plate about 400 mg to about 800 mg Ni-64 per target plate.

The plating bath may include water in an amount of about 10 mL to about 30 mL, about 30 mL to about 60 mL, or about 60 mL to about 100 mL to plate about 400 mg to about 800 mg of Ni-64 per target. The amount of water may be from about 61 mL to about 99 mL, about 62 mL to about 98 mL, about 63 mL to about 97 mL, about 64 mL to about 96 mL, about 65 mL to about 95 mL, about 66 mL to about 94 mL, about 67 mL to about 93 mL, about 68 mL to about 92 mL, about 69 mL to about 91 mL, about 70 mL to about 90 mL, about 71 mL to about 89 mL, about 72 mL to about 88 mL, about 73 mL to about 87 mL, about 74 mL to about 86 mL, about 75 mL to about 85 mL, about 76 mL to about 84 mL, about 77 mL to about 83 mL, about 78 mL to about 82 mL, about 79 mL to about 81 mL, or about 80 mL to about 80.5 mL to plate about 400 mg to about 800 mg Ni-64 per target plate. In some embodiments, the amount of water may be from about 88 mL to about 92 mL to plate about 400 mg to about 800 mg Ni-64 per target plate. In some embodiments, the amount of water may be about 90 mL to plate about 400 mg to about 800 mg Ni-64 per target plate.

The initial Ni-64 concentration in the Ni-64 plating bath may be from about 10 mg/ml to about 40 mg/mL to plate about 400 mg to about 800 mg Ni-64 per target plate. The initial Ni-64 concentration may be from about 10 mg/mL to about 40 mg/mL, about 11 mg/mL to about 39 mg/mL, about 12 mg/mL to about 38 mg/mL, about 13 mg/mL to about 37 mg/mL, about 14 mg/mL to about 36 mg/mL, about 15 mg/mL to about 35 mg/mL, about 16 mg/mL to about 34 mg/mL, about 17 mg/mL to about 33 mg/mL, about 18 mg/mL to about 32 mg/mL, about 19 mg/mL to about 31 mg/mL, about 20 mg/mL to about 30 mg/mL, about 21 mg/mL to about 31 mg/mL, about 22 mg/mL to about 30 mg/mL, about 23 mg/mL to about 29 mg/mL, about 24 mg/mL to about 28 mg/mL, or about 25 mg/mL to about 27 mg/mL. In some embodiments, the initial Ni-64 concentration may be about 10 mg/mL to about 12 mg/mL, about 12 mg/mL to about 14 mg/mL, about 14 mg/mL to about 16 mg/mL, about 16 mg/mL to about 18 mg/mL, about 18 mg/mL to about 20 mg/mL, about 20 mg/mL to about 22 mg/mL, about 22 mg/mL to about 24 mg/mL, about 24 mg/mL to about 26 mg/mL, about 26 mg/mL to about 28 mg/mL, about 28 mg/mL to about 30 mg/mL, about 30 mg/mL to about 32 mg/mL, about 32 mg/mL to about 34 mg/mL, about 34 mg/mL to about 36 mg/mL, about 36 mg/mL to about 38 mg/mL, or about 38 mg/mL to about 40 mg/mL to plate about 400 mg to about 800 mg Ni-64 per target plate.

In some embodiments, the plating bath may include about 1350 mg to about 2250 mg of Ni-64, about 0 to about 4.5 g of boric acid, about 29 mL to about 31 mL of ammonium hydroxide, and about 88 mL to about 92 mL of water to plate about 400 mg to about 800 mg Ni-64 per target plate.

### ii) Electrochemical Cell/Preparation

After preparing the Ni-64 plating bath, an electrochemical cell may be assembled. The electrochemical cell may be an electroplating cell. The electroplating cell may house one or more target substrates and an anode. The electroplating cell may be fabricated from materials compatible with strong acids and electrochemical environments, such as glass, polypropylene, high-density polyethylene, or fluoropolymer-lined vessels. The anode may be formed of an inert material, for example, platinum, graphite, or titanium coated with a noble metal.

The electroplating cell may have one target or more targets. In some embodiments, the electroplating cell may hold a single target, a double target, or a triple target. In some embodiments, the electrochemical cell may be a double-target assembly cell. In some embodiments, the electrochemical cell may be a triple-target assembly cell.

The one or more targets may be formed of a conductive backing material such as gold, silver, copper, platinum, or other metals compatible with high-energy proton bombardment. The targets may be positioned to ensure uniform electric field distribution and plating thickness. In certain embodiments, the plating cell includes mechanical or hydraulic fixtures to maintain a stable orientation of each target during deposition.

A leak test may be performed by adding water to the assembled electrochemical cell. A leak test is an evaluation performed on a plating cell, flow path, or other fluid-handling component to verify the integrity of seals, gaskets, joints, and connections prior to use. The test typically involves introducing a liquid or gas into the system under controlled conditions and inspecting the system for any loss of material, pressure decay, or moisture formation at potential failure points. A successful leak test confirms that the system is properly sealed, free from defects, and capable of retaining the plating bath throughout the electrodeposition process. After the leak test, water may be removed from the electrochemical cell.

After the electrochemical cell passes the leak test, an acid solution may be added to the electrochemical cell. The acid may be nitric acid, hydrochloric acid, sulfuric acid, phosphoric acid, hydrobromic acid, hydroiodic acid, or a mixture thereof. In some embodiments, the acid may be nitric acid. The acid solution may be in the electrochemical cell for at least 15 minutes. The acid solution may be in the electrochemical cell for at least 20 minutes, at least 25 minutes, at least 30 minutes, or at least 35 minutes. The acid solution may be removed from the electrochemical cell. The electrochemical cell may be rinsed with water.

iii) Electrodeposition of Ni-64

With the electroplating cell assembled, Ni-64 may be electrodeposited onto the one or more targets by applying an electrical current or potential difference between the anode and the target(s). The applied current may be constant, stepped, pulsed, or otherwise controlled to achieve optimal plating characteristics. During electrodeposition, Ni-64 ions in solution are reduced at the surface of the target(s), forming a metallic nickel layer that increases in mass over time. The plating conditions, including current, time, and bath composition, may be selected to promote uniform deposition and strong adhesion. In some embodiments, the plating bath may be continuously or intermittently stirred, recirculated, or otherwise mixed to maintain homogeneity of Ni-64 ion distribution.

The electrodeposition process continues until at least 99% percent of the initial Ni-64 concentration in the bath is depleted. The electrodeposition process may continue until at least about 99%, about 99.1%, about 99.2%, about 99.3%, about 99.4%, about 99.5%, about 99.6%, about 99.7%, about 99.8%, about 99.9%, about 99.91%, about 99.92%, about 99.93%, about 99.94%, about 99.95%, about 99.96%, about 99.97%, about 99.98%, about 99.99%, or about 100.00% of the initial Ni-64 concentration in the bath is depleted. Alternatively, the electrodeposition process may continue until ≥99%, ≥99.1%, ≥99.2%, ≥99.3%, ≥99.4%, ≥99.5%, ≥99.6%, ≥99.7%, ≥99.8%, ≥99.9%, ≥99.91%, ≥99.92%, ≥99.93%, ≥99.94%, ≥99.95%, ≥99.96%, ≥99.97%, ≥99.98%, or ≥99.99% of the initial Ni-64 concentration in the bath is depleted. The electrodeposition process may continue until 99% to 100% percent of the initial Ni-64 concentration in the bath is depleted.

Depletion may be monitored directly, for example by sampling the bath and analyzing Ni-64 concentration via inductively coupled plasma optical emission spectroscopy (ICP-OES), or indirectly, such as by tracking current efficiency, deposition time, or mass gain of the plated target(s). Depositing until at least 99% depletion ensures near-quantitative incorporation of valuable enriched Ni-64 onto the targets, thereby minimizing waste and improving production economics. In certain embodiments, deposition continues until full (e.g., 100%) depletion is achieved, or until the plating rate naturally tapers as Ni-64 concentration approaches trace levels.

The electrodeposition process may be carried out using an electrodeposition current of about 100 mA to about 500 mA. The electrodeposition current may be about 110 mA to about 490 mA, about 120 mA to about 480 mA, about 130 mA to about 470 mA, about 140 mA to about 460 mA, about 150 mA to about 450 mA, about 160 mA to about 440 mA, about 170 mA to about 430 mA, about 180 mA to about 420 mA, about 190 mA to about 410 mA, about 200 mA to about 400 mA, about 210 mA to about 390 mA, about 220 mA to about 380 mA, about 230 mA to about 370 mA, about 240 mA to about 360 mA, about 250 mA to about 350 mA, about 260 mA to about 340 mA, about 270 mA to about 330 mA, about 280 mA to about 320 mA, about 290 mA to about 310 mA, or about 300 mA to about 305 mA. In some embodiments the electrodeposition current may be from about 200 mA to about 250 mA, about 250 mA to about 300 mA, about 300 mA to about 350 mA, about 350 mA to about 400 mA, about 400 mA to about 450 mA, or about 450 mA to about 500 mA.

The electrodeposition process may be carried out for a duration of about 60 minutes to about 420 minutes. The electrodeposition time may be about 60 minutes to about 420 minutes, about 70 minutes to about 410 minutes, about 80 minutes to about 400 minutes, about 90 minutes to about 390 minutes, about 100 minutes to about 380 minutes, about 110 minutes to about 370 minutes, about 120 minutes to about 360 minutes, about 130 minutes to about 350 minutes, about 140 minutes to about 340 minutes, about 150 minutes to about 330 minutes, about 160 minutes to about 320 minutes, about 170 minutes to about 310 minutes, about 180 minutes to about 300 minutes, about 180 minutes to about 290 minutes, about 190 minutes to about 280 minutes, about 200 minutes to about 270 minutes, about 210 minutes to about 260 minutes, about 220 minutes to about 250 minutes, or about 230 minutes to about 240 minutes. In some embodiments, the electrodeposition current may be from about 200 mA to about 250 mA, about 250 mA to about 300 mA, about 300 mA to about 350 mA, about 350 mA to about 400 mA, about 400 mA to about 450 mA, or about 450 mA to about 500 mA. In some embodiments, the duration may be from about 60 minutes to about 420 minutes, about 60 minutes to about 120 minutes, about 120 minutes to about 150 minutes, about 120 minutes to about 180 minutes, about 180 minutes to about 240 minutes, about 240 minutes to about 300 minutes, about 300 minutes to about 360 minutes, about 360 minutes to about 420 minutes, about 220 minutes to about 240 minutes, or about 380 minutes to about 400 minutes.

In some embodiments, electrodepositing Ni-64 may be performed using a current of about 200 mA to about 500 mA for a duration of about 60 minutes to about 420 minutes.

After the desired degree of depletion is reached, the plated target(s) may be removed from the electroplating cell. The plated targets may be rinsed with deionized water, dilute acid, or other cleaning solutions to remove residual bath components. The resulting Ni-64-coated targets may then be dried, inspected for plating uniformity, adhesion, and thickness, and mounted into cyclotron target holders for subsequent irradiation. The deposited Ni-64 layer produced by the described method is typically robust, uniform, and free of defects that might compromise thermal performance or mechanical stability during bombardment.

The methods described herein provide high-yield, efficient electrodeposition of enriched nickel-64 suitable for large-scale production of Cu-64 or Co-61 radionuclides. By selecting the initial concentration of Ni-64, controlling bath chemistry, and depositing until near-complete depletion, the process enables predictable plating outcomes and minimizes losses of isotopically enriched material.

### An Electrodeposited Plate

The disclosure is also directed to an electrodeposited plate. The electrodeposited plate may include a Ni-64 plated plate produced according to the methods described herein. The electrodeposited plate may include a target substrate onto which a layer of Ni-64 has been deposited through the electrodeposition process.

In some embodiments, the plated surface of the electrodeposited plate may exhibit no visible removal of the deposited Ni-64 following performance of an adhesion test, indicating strong adherence of the deposited layer. An adhesion test may include an adhesive tape application and removal test. In certain embodiments, the electrodeposited plate may be suitable for subsequent irradiation and may be bombarded under cyclotron operating conditions to generate radionuclides such as Cu-64 and Co-61 for use in PET imaging applications.

In other embodiments, the electrodeposited plate may possess a uniform and adherent Ni-64 coating across the plated surface, providing consistent thickness and structural integrity of the deposit. The Ni-64 plated plate may further exhibit a uniform gray appearance and an absence of flaking or particulate loss when subjected to adhesion testing, demonstrating the robustness and stability of the electrodeposited layer.

### Definitions

Several definitions that apply throughout the above disclosure will now be presented. As used herein, the terms “comprising,” “having,” and “including” are used interchangeably in their open, non-limiting sense. The terms “a,” “an,” and “the” are understood to encompass the plural as well as the singular. Thus, the term “a mixture thereof” also relates to “mixtures thereof.”

Generally, the ranges provided are meant to include every specific range within, and combination of sub ranges between, the given ranges. Thus, a range from 1-5, includes specifically 1, 2, 3, 4, and 5, as well as sub ranges such as 2-5, 3-5, 2-3, 2-4, 1-4, etc. All ranges and values disclosed herein are inclusive and combinable. For example, any value or point described herein that falls within a range described herein can serve as a minimum or maximum value to derive a sub-range, etc.

As used herein, “about” refers to numeric values, including whole numbers, fractions, percentages, etc., whether or not explicitly indicated. The term “about” generally refers to a range of numerical values, for instance, ±0.5-1%, ±1-5% or ±5-10% of the recited value, that one would consider equivalent to the recited value, for example, having the same function or result.

As used herein, “enriched nickel-64” or “enriched Ni-64” refers to nickel material in which the naturally occurring isotopic abundance of Ni-64 has been increased through isotopic enrichment processes such as gas centrifugation, electromagnetic separation, or other isotope-separation techniques. Enriched Ni-64 includes nickel compositions having a Ni-64 isotopic fraction greater than the natural abundance level of approximately 0.93%, and may include materials having enrichment levels of at least about 50%, at least about 90%, or at least about 95% Ni-64, or higher, depending on production requirements. Enriched Ni-64 may be provided in metallic or salt form and may be used to prepare the Ni-64 plating bath described herein. The term encompasses both virgin Ni-64, which has not previously been plated or irradiated, and recovered Ni-64, which has been reclaimed following deposition and irradiation and optionally purified for reuse.

As used herein, “virgin Ni-64” denotes isotopically enriched nickel-64 material that has not been previously deposited, irradiated, dissolved, or subjected to any recovery or purification processes and is introduced into the plating bath in its original as-purchased form.

As used herein, “recovered Ni-64” denotes nickel-64 material that has been previously plated and irradiated and subsequently recovered through dissolution, isolation, purification, or other chemical processing for reuse in a subsequent deposition cycle.

As used herein, the term “plating bath” refers to a liquid electrochemical solution containing one or more nickel species, including Ni-64, that is suitable for electrodeposition onto a target substrate. The plating bath may include dissolved metal ions, acids, bases, buffers, complexing agents, conductivity enhancers, stabilizers, surfactants, or other additives that facilitate or control the electrodeposition process. In certain embodiments, the plating bath comprises Ni-64 in a soluble form together with one or more acid or base components to adjust or maintain pH, and may further include boric acid or other weak acids, ammonium hydroxide or other weak bases, or additional constituents that promote uniform metal deposition. The plating bath may be prepared in any desired volume, concentration, or composition effective to enable deposition of Ni-64 onto one or more targets during electrochemical operation.

As used herein, the term “electrochemical cell” refers to a device or assembly containing two or more electrodes in electrical communication through an electrolyte, in which an electrochemical reaction occurs when a potential or current is applied or generated. An electrochemical cell may include a cathode, an anode, an electrolyte solution, electrical connections, and optionally one or more housings, seals, or flow components. Electrochemical cells encompass both electrolytic cells and galvanic cells and include, but are not limited to, electroplating cells, electrolysis cells, and other systems designed to drive or sustain redox reactions.

As used herein, the term “electroplating cell” refers to a type of electrochemical cell that is specifically configured for electrodeposition of a metal onto a substrate. An electroplating cell includes a cathode, which may be or may include the target onto which nickel-64 is deposited, an anode, and a plating bath containing dissolved metal ions suitable for electrodeposition. The electroplating cell is configured to receive an applied current or potential such that metal ions in the plating bath are reduced and deposited onto the cathode surface. Electroplating cells represent a subset of electrochemical cells. The terms electrochemical cell and electroplating cells are used interchangeably.

As used herein, the term ‘target’ or ‘target substrate’ refers to a conductive backing material onto which Ni-64 is deposited. The target may include, without limitation, gold-coated substrates, copper, platinum, silver, or other conductive materials suitable for electrochemical deposition and for subsequent irradiation in a cyclotron target station.

As used herein, a ‘plated target’ refers to a target substrate onto which a layer of Ni-64 has been deposited by the electrodeposition methods described herein.

As used herein, an ‘adhesion test’ refers to any tape-pull or adhesive-based evaluation in which tape is applied to the plated surface under light pressure and removed to assess visible removal, flaking, or delamination of deposited Ni-64.

As used herein, a ‘uniform deposit’ or ‘uniform and adherent layer’ refers to a Ni-64 coating that exhibits consistent coloration and thickness over the plated surface, with no visible cracks, flaking, powdering, or areas of non-adherence when subjected to visual inspection and adhesion testing.

As used herein, ‘full depletion’ or ‘at least 99% depletion’ refers to the condition in which at least 99% (or more, as specified) of the initial Ni-64 concentration has been removed from solution, as determined by direct analytical measurement (e.g., ICP-OES) or by calculating the mass gain of the plated target(s).

As used herein, the term ‘Ni-64 concentration’ refers to the mass of soluble Ni-64 species present per unit volume of plating bath, expressed in mg/mL, unless otherwise indicated.

As used herein, “uniformity” refers to the degree to which a deposited layer, coating, or material exhibits consistent physical characteristics across its surface or throughout its volume. Uniformity may include consistency in one or more of thickness, mass distribution, morphology, composition, adhesion, or visual appearance (e.g., color or texture). A deposit may be considered “uniform” when variations in these characteristics fall within acceptable tolerances for the intended application. Uniformity may be assessed qualitatively (e.g., visual inspection for discoloration, cracking, or peeling) or quantitatively (e.g., measuring thickness at multiple points, evaluating mass gain, surface roughness, or compositional gradients).

### Examples

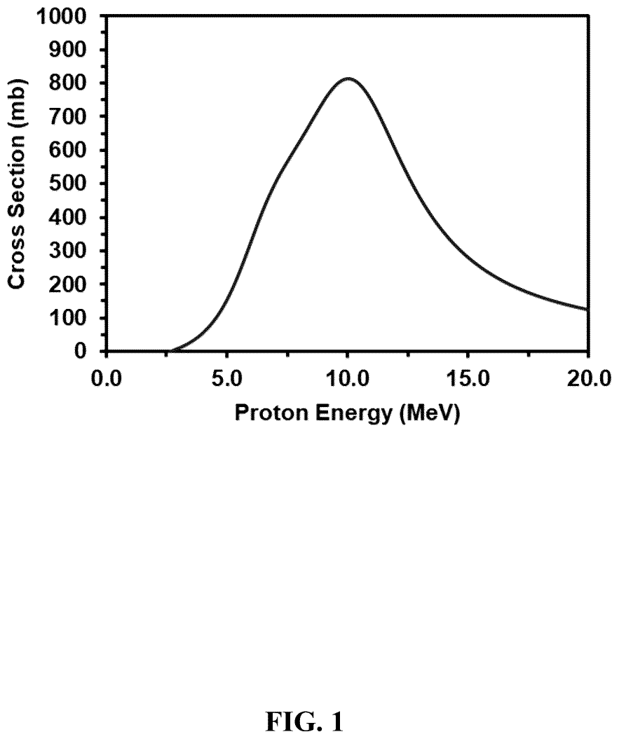

Copper-64 (Cu-64, ⁶⁴Cu, t½=12.7 h) is a diagnostic radionuclide capable of being imaged via positron-emission tomography (PET). Cu-64 can be produced via the nuclear reaction Ni-64(p,n)Cu-64 using highly enriched Ni-64 and particle accelerators (cyclotron, LINAC, etc.). Practically, production cross sections decrease significantly at lower proton energies (e.g., 5-7 MeV). The reaction cross section values were sourced from the International Atomic Energy Agency's (IAEA) recommended experimental cross sections. The Pade-9 trendline generated from those data was used for calculating the Cu-64 TTY (FIG. 1).

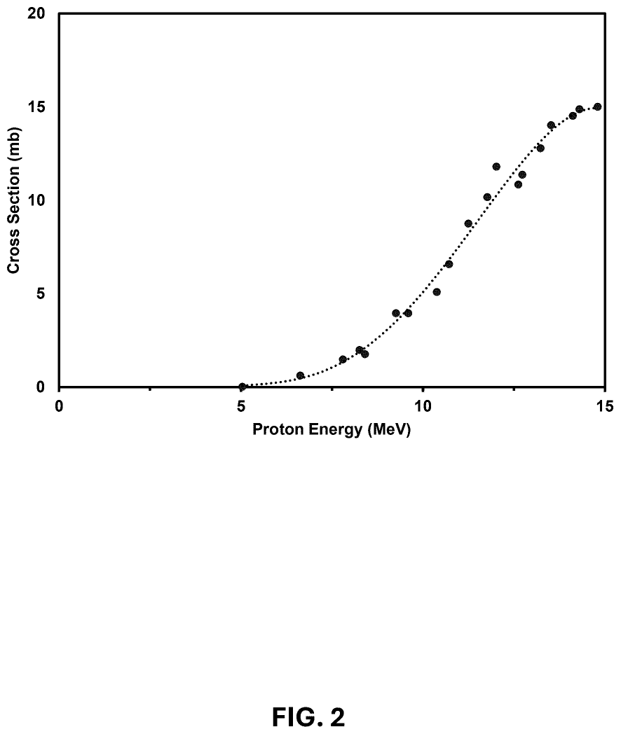

The threshold energy for the Ni-64(p,α)Co-61 reaction is 0.7 MeV, however the experimental cross section drops effectively to zero below 5 MeV. Therefore, integration was performed using 5 MeV as the proton exit energy to evaluate the maximum possible theoretical production yields. The reaction cross section values for 5-15 MeV protons were approximated by fitting a polynomial trendline to experimental measurements by Qaim, et al. (FIG. 2) The trendline was fit with an R-square (R2) value of 0.99.

To determine thick target yields for Cu-64 and Co-61 production, the following equation was used.

$$A = nI ( 1 - {e}^{- λ t} ) {\int }_{{E}_{exit}}^{{E}_{entry}} σ ( E ) \frac{dE}{S ( E )}$$

where A=activity at end of bombardment (EOB), n=target nuclei/cm³, I=current (protons/s), σ=reaction cross section (cm²), λ=decay constant of produced radionuclide (s−1), t=irradiation time(s), E=proton energy (MeV) and S(E)=stopping power of protons in nickel (MeV/cm).

SRIM-2013 was used to determine the effective thickness of Ni-64 required to fully degrade protons of varying incident energies and to calculate the average proton exit energies presented in Table 1. The masses of Ni-64 were calculated assuming a 5-degree beam angle and a plating area of 23 cm². The density of Ni used to calculate the mass of Ni-64 was 8.908 g/cm³. The results summarized in Table 1 are considered practical thickness requirements for degrading the beam to 5 MeV.

TABLE 1
Effective target thickness requirements to degrade proton
beams of different incident energies to 5 MeV exit energy

| Incident | Average | Effective | Actual | |
|---|---|---|---|---|
| proton energy | proton exit | thickness | thickness | Ni-64 mass |
| (MeV) | energy (MeV) | (μm) | (μm) | required (g) |
| 15.0 | 5.02 | 390 | 34 | 0.70 |
| 14.5 | 5.04 | 364 | 32 | 0.65 |
| 14.0 | 5.00 | 340 | 30 | 0.61 |
| 13.5 | 5.03 | 313 | 27 | 0.56 |
| 13.0 | 4.97 | 290 | 25 | 0.52 |
| 12.5 | 5.00 | 267 | 23 | 0.48 |
| 12.0 | 4.96 | 245 | 21 | 0.44 |

A target plating process was developed based on the calculated mass of Ni-64 across the potential bombardment energy range, or 400-750 mg per target.

### Example 1: Recovery of Ni-64 Chloride for Plating Bath Preparation

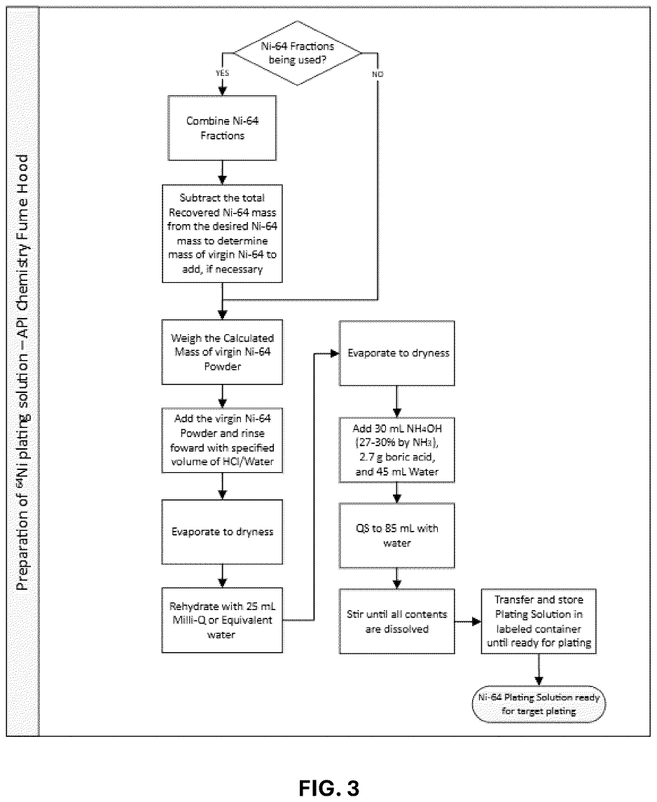

The nickel-64 recovery and preparation process was carried out to obtain a dried solid of ⁶⁴NiCl₂ suitable for direct use in a subsequent plating bath. As shown in FIG. 3, the recovery procedure began with collecting between zero and three fractions originating from strip or purification operations, each fraction containing dissolved ⁶⁴NiCl₂ in a matrix of 6-9 M hydrochloric acid (HCl). The volume of each fraction was accurately measured using a graduated cylinder. The fractions were combined in a large round-bottom flask.

Using previously established Ni-64 concentration data for each fraction, the total mass of Ni-64 was calculated. This calculated mass was compared to the desired final Ni-64 mass required for the plating bath. When the recovered Ni-64 mass was insufficient, an additional amount of virgin Ni-64 metal powder was weighed to achieve the target total Ni-64 mass. The virgin Ni-64 was added directly to the flask and rinsed with an equal mixture of concentrated HCl and water to ensure full transfer into the solution.

The flask was then placed in an evaporation setup and heated until all free acid was removed, leaving a dry residue of ⁶⁴NiCl₂ adhered to the flask. The dried solid was cooled until warm to the touch and then rehydrated with 25 mL deionized water. If necessary, the mixture was transferred to a smaller flask, and the solution was again evaporated to dryness to further purify the Ni-64 chloride.

The resulting dried ⁶⁴NiCl₂ solid was then capped and stored until initiation of the plating bath preparation process. This method reliably produced a purified, dry Ni-64 chloride material of known mass, suitable for direct incorporation into the bath preparation steps described in later examples.

### Example 2: Preparation of Ni-64 Plating Bath

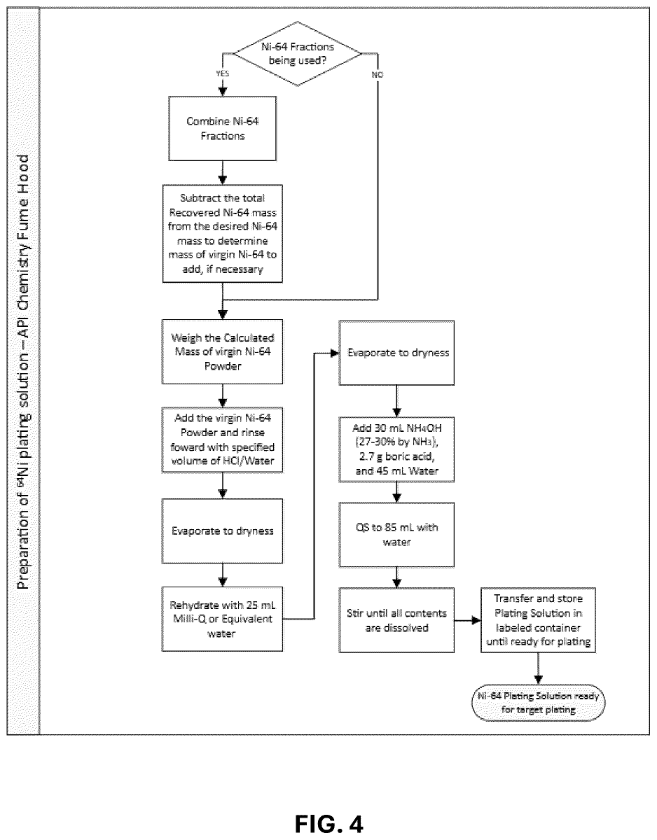

A Ni-64 plating bath was prepared beginning with either virgin Ni-64 metal powder or a mixture of virgin Ni-64 and a predetermined amount of dried ⁶⁴NiCl₂ obtained from a previous Ni-64 recovery process as described in Example 1. As illustrated in FIG. 4, the Ni-64 source material was placed into an appropriately sized flask, and 2.7 g of boric acid, 35 mL of water, 20 mL of ammonium hydroxide (NH₄OH), and a magnetic stir bar were added. The mixture was stirred until a clear, homogeneous blue solution formed.

The resulting solution was transferred to a 100 mL graduated cylinder, using a funnel to retain the stir bar. The original flask was then rinsed with 10 mL of water, and the rinse was added to the graduated cylinder. The flask was subsequently rinsed with 10 mL of NH₄OH, and this rinse was likewise added to the cylinder to ensure complete transfer of Ni-64 into the bath.

Water was then added to the graduated cylinder to bring the total volume to 85 mL, and the solution was mixed thoroughly with a long pipette until homogeneous. After the solution was transferred to the plating cell in later steps, the graduated cylinder was rinsed with an additional 5 mL of water, which was added to the plating cell, resulting in a final plating bath volume of 90 mL. The target values and acceptable ranges for these plating bath parameters are provided in Table 2.

This procedure reliably produced a homogeneous Ni-64 plating bath suitable for electrodeposition.

TABLE 2
Plating Bath Parameters

| | | | |
|---|---|---|---|
| Bath Input | Target | Range | Comment |

| | | | | | |
|---|---|---|---|---|---|
| Ni-64 | 1800 | mg | 1350-2250 | mg | 600 mg per target |
| Boric Acid | 2.7 | g | 0-4.5 | g | — |
| NH₄OH | 30 | mL | 29-31 | mL | — |
| Bath Volume | 90 | mL | 88-92 | mL | QS* with HRW |

“QS” or “quantity sufficient” refers to adding enough solvent to reach a desired final volume.

### Example 3: Preparation of Plating Cell and Targets

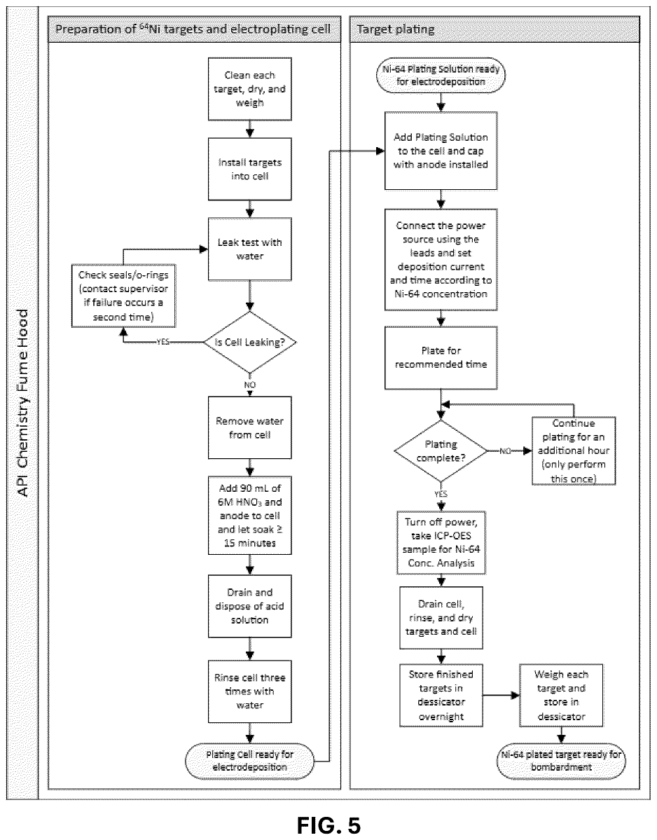

Prior to electrodeposition, the plating cells and targets were prepared following the procedure illustrated in FIG. 5 (left). The preparation began by thoroughly cleaning the cell components and the individual targets using wipes saturated with a 70/30 isopropanol/water solution. Particular attention was given to cleaning the O-rings and the gold-coated target surfaces to ensure proper sealing and to avoid contamination during electrodeposition. After cleaning, the components were allowed to dry completely.

The dry targets were then assembled into the plating cell, and the integrity of the seal was verified by performing a leak check using deionized water. Once a satisfactory seal was confirmed, an additional cleaning step was performed by filling the assembled cell with 6 M nitric acid and allowing it to soak for 15 minutes. The acid solution was removed, and the cell was rinsed three times with Milli-Q water to eliminate any residual nitric acid.

After the final rinse was drained, the plating cell was considered fully prepared and ready to receive the Ni-64 plating bath for electrodeposition. This preparation procedure ensured a clean, contaminant-free environment necessary for forming uniform, adherent Ni-64 deposits.

### Example 4: Electrodeposition of Ni-64 onto Targets/Target Plating

The electrodeposition procedure was carried out according to the process flow depicted in FIG. 5 (right). After preparing the Ni-64 plating bath and assembling the cleaned plating cell as described in previous examples, the plating bath was introduced into the cell by pouring the solution directly over the assembled targets. To ensure full transfer of the Ni-64 solution, the graduated cylinder used during bath preparation was rinsed with 5 mL of water, and the rinse was added to the cell.

A platinum (Pt) anode was then inserted into the cell, and electrical leads were attached to both the anode and the targets. The power supply was programmed to deliver the predetermined electrodeposition current and deposition time corresponding to the target Ni-64 mass, as shown in Table 3. Deposition was initiated, and the cell was visually monitored to confirm the onset and continuation of Ni-64 deposition on each target.

At the end of the programmed deposition period, the Pt anode was removed and rinsed thoroughly. The remaining plating bath solution was collected for Ni-64 concentration analysis by ICP-OES to quantify residual Ni-64 and confirm deposition efficiency. The plating cell and targets were then rinsed with 90 mL of water to remove residual plating solution.

Each target was removed from the cell, blotted dry using a Kimwipe, and placed in a desiccator for a minimum of 12 hours to ensure complete drying prior to weighing. The dried targets were weighed to determine the mass of Ni-64 deposited. If the deposited mass fell below the target range, the Ni-64 layer was chemically stripped and purified, and the recovered Ni-64 was reintroduced into the Ni-64 recovery workflow for reuse in a subsequent plating cycle.

TABLE 3
Recommended Parameters for Tri-Target Plating

| Targeted Ni Mass on Plate | Plating Current | Minimum Plating Time |
|---|---|---|
| (mg) | (mA) | (min) |
| 650-750 | 500 | 150 |
| 550-649 | 250 | 240 |
| <550 | 200 | 360 |

### Example 5: Effect of the Number of Targets Deposited Simultaneously in the Tri-Target Cell

The impact of the number of targets deposited simultaneously on Ni-64 deposit quality was evaluated using the standard Tri-Target Cell. The standard Tri-Target Cell accommodates between one and three targets at once. To isolate the effect of target count, each experiment used a 0% Ni excess plating bath, meaning the exact desired mass of nickel per target, 750 mg Ni as NiCl₂, was included in the bath at the start of each run. The pH and boric acid concentration were kept constant across all depositions, and electrodeposition was carried out at 500 mA per target for 120 minutes.

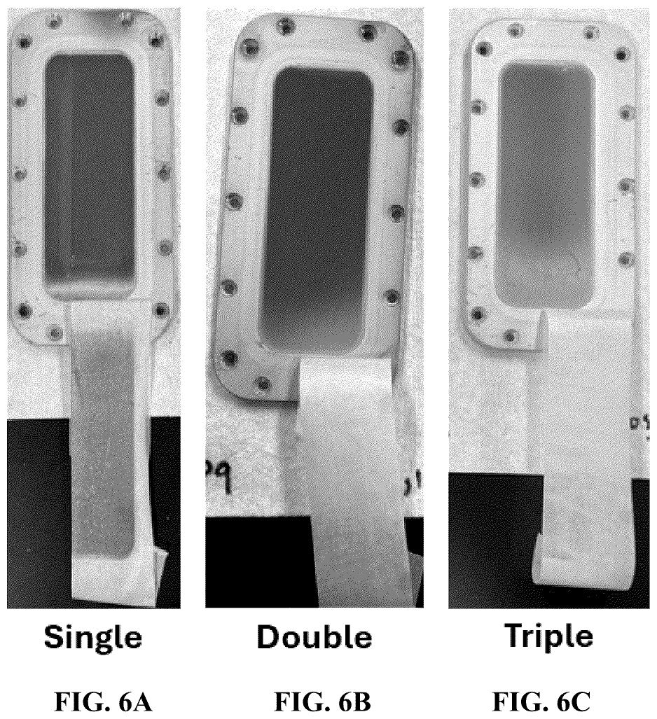

Following deposition, each target was inspected visually for color and homogeneity. Representative visual results and adhesion test outcomes for each configuration are shown in FIGS. 6A-6C. As shown in FIGS. 6A-6C, the appearance of the deposits varied depending on whether one (FIG. 6A), two (FIG. 6B), or three targets (FIG. 6C) were plated simultaneously.

As shown in FIG. 6A, in the single-target deposition, the resulting Ni-64 layer exhibited a noticeably dark appearance, and adhesion testing using a tape pull revealed that a significant amount of Ni was removed from the surface. This indicated a lower-quality deposit and suggested the presence of nickel oxide species within the plated layer.

As shown in FIG. 6B, in the double-target deposition, the visual appearance was similar, with deposits showing darker coloration than desired. However, tape testing removed substantially less Ni than in the single-target case, indicating somewhat improved adhesion.

As shown in FIG. 6C, the triple-target deposition produced the highest-quality results. The plated surfaces were uniformly gray in color and exhibited no visible Ni removal upon tape testing, demonstrating excellent adhesion. Although a darkened region was observed in the upper 80-90% of the deposit, this effect was attributed to the positioning of the platinum anode within the cell. Subsequent depositions conducted after adjusting the anode length and placement did not exhibit this localized darkening, confirming that the phenomenon was cell-geometry related rather than a function of the deposition parameters.

In all experiments, lighter gray deposits were considered indicative of higher-quality Ni-64 plating, whereas darker regions suggested increased formation of nickel oxide species such as Ni₂O₃ and NiO. These darker deposits are believed to behave differently under bombardment and are therefore undesirable for Cu-64 production.

Adhesion testing was performed using a standard tape test method. Optimal deposits, typically those produced during three-target deposition, exhibited no visible Ni removal upon tape testing, while darker deposits obtained under single-target conditions occasionally showed minor flaking.

To quantify plating efficiency, aliquots of the post-deposition plating bath were analyzed via ICP-OES to determine the residual Ni content. Ni-64 depletion efficiency was assessed by ICP-OES analysis of the post-plating solutions. The single-target deposition retained approximately 85 mg of unplated Ni-64 in solution. The double-target deposition retained approximately 36 mg, and the triple-target deposition retained approximately 34 mg. Subsequent triple-target experiments consistently showed even lower residual Ni-64 levels of 10-20 mg, confirming that the triple-target configuration more effectively depleted Ni-64 from solution within the standard 120-minute plating period. For three-target depositions, the remaining Ni mass was typically 10-20 mg, confirming >99% depletion from the bath. In contrast, single-target depositions showed substantially higher residual Ni levels (e.g., ˜85 mg), indicating that a longer deposition time would be required to achieve full depletion when only one target is present.

These results demonstrate that simultaneous deposition onto three targets produces superior deposit uniformity, improved adhesion, and more efficient depletion of Ni from solution, making three-target operation the preferred configuration for high-quality Ni-64 plating.

Collectively, these findings demonstrate that triple-target deposition produces the lightest-colored, most adherent, and most efficiently depleted Ni-64 deposits, making this configuration superior to single- or double-target plating and therefore the preferred mode for further development of full-depletion plating methods.

### Example 6: Ni-64 Mass Depletion from Solution at Varying Electrodeposition Currents

The effect of electrodeposition current on the rate of Ni-64 depletion from the plating bath was evaluated to determine the minimum deposition time required for full consumption of Ni-64 during electrodeposition. This analysis provides insight into how long deposition should proceed to avoid unnecessary plating time once all available Ni-64 has been removed from solution.

Experiments were conducted using plating baths formulated to contain the equivalent of 750 mg of Ni-64 per target, and electrodeposition was performed at 500 mA, 350 mA, and 200 mA. To monitor Ni-64 concentration during plating, 1 mL aliquots of the plating bath were collected at the start of deposition and at regular 30-minute intervals thereafter. Each aliquot was analyzed by ICP-OES to quantify the remaining Ni-64 in solution. To maintain a constant bath volume, 1 mL of Milli-Q water was added after each sampling. Sampling continued until the Ni content in solution fell below 1 mg.

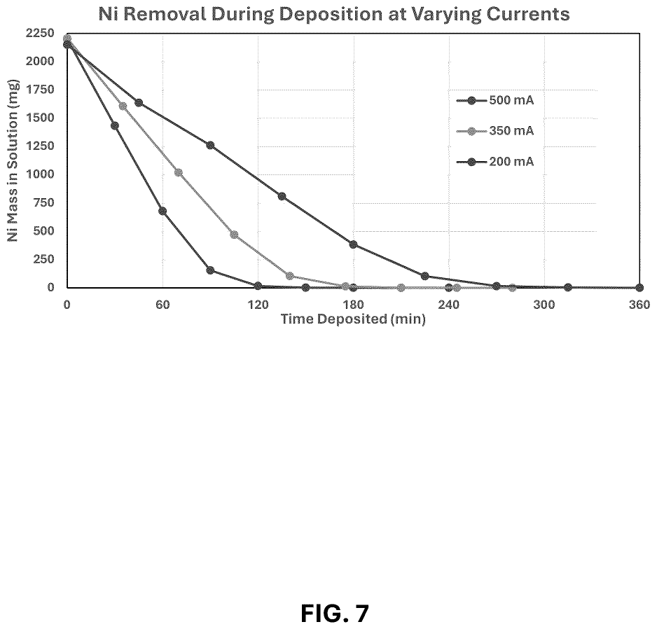

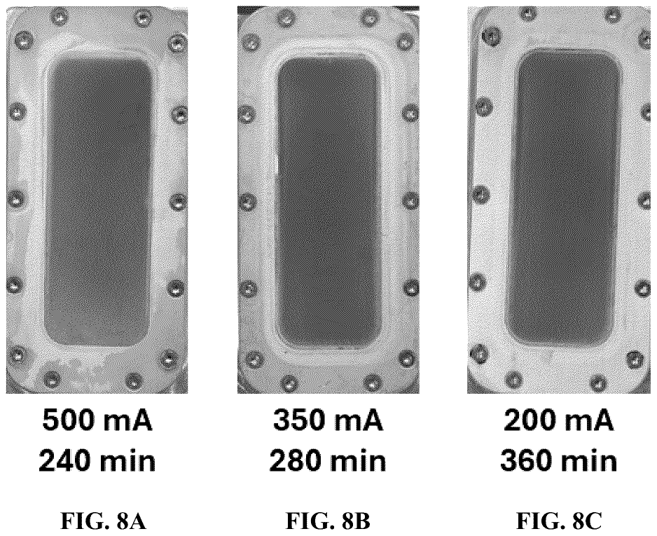

The results of the depletion experiments conducted at 500 mA, 350 mA, and 200 mA are summarized in Table 4, illustrated graphically in FIG. 7, and visually demonstrated by the plated targets shown in FIGS. 8A-8C. As reflected in these data, the electrodeposition current had a significant impact on the rate at which Ni-64 was removed from solution during plating. The highest current, 500 mA, produced the fastest depletion, achieving ≥99% removal of Ni-64 within approximately 120 minutes, with complete depletion occurring between 150 and 180 minutes. At the intermediate current of 350 mA, depletion occurred more gradually, with ≥99% removal reached at approximately 175 minutes and full depletion achieved between 210 and 245 minutes. The slowest depletion rate was observed at 200 mA, where ≥99% Ni-64 removal occurred at approximately 270 minutes, and nearly 360 minutes were required to reach full depletion.

Representative Ni-64 deposits obtained from these experiments are shown in FIGS. 8A-8C. Across all current levels tested, the deposits exhibited uniform gray coloration and passed adhesion testing without evidence of Ni removal. The slight acceleration in depletion time observed in these experiments, relative to optimal conditions, was attributed to the repeated removal of aliquots for ICP-OES sampling. In practical full-volume plating operations without sampling, deposition times are expected to be marginally longer but remain consistent with the trends demonstrated in Table 4 and FIG. 7.

TABLE 4
Mass of Ni left in solution at varying times during
deposition for the three currents studied.

| 500 mA | | 350 mA | | 200 mA | |
|---|---|---|---|---|---|
| Time | Mass Ni in | Time | Mass Ni in | Time | Mass Ni in |
| (min) | Solution (g) | (min) | Solution (g) | (min) | Solution (g) |
| 0 | 2200.0 | 0 | 2205.4 | 0 | 2148.5 |
| 30 | 1431.4 | 35 | 1606.0 | 45 | 1635.5 |
| 60 | 677.0 | 70 | 1019.2 | 90 | 1259.4 |
| 90 | 153.4 | 105 | 468.4 | 135 | 807.7 |
| 120 | 15.5 | 140 | 104.2 | 180 | 382.0 |
| 150 | 1.3 | 175 | 12.9 | 225 | 102.7 |
| 180 | 0.2 | 210 | 1.6 | 270 | 15.1 |
| 210 | <LOQ | 245 | 0.2 | 315 | 2.4 |
| 240 | 0.6 | 280 | <LOQ | 360 | 0.6 |

These results confirm that electrodeposition current strongly influences Ni-64 depletion kinetics and that higher currents achieve faster depletion, while lower currents require extended deposition durations. Importantly, all current levels tested produced acceptable deposit quality, demonstrating that plating time may be adjusted to achieve ≥99% depletion without compromising adhesion or visual properties of the deposited Ni-64.

It is noted that the depletion times in these experiments were slightly accelerated relative to standard deposition operations due to the periodic removal of aliquots for ICP-OES analysis, which marginally decreased the Ni-64 mass in solution during plating. Under typical plating conditions without sampling, actual depletion times are expected to be slightly longer but remain consistent with the trends presented in Table 4 and FIG. 7.

Despite differences in depletion rates, all plated targets produced at the three current levels exhibited acceptable deposit quality, with uniform gray appearance and no observable Ni removal during tape-based adhesion testing.

### Example 7: Effect of Time and Current

The effect of varying the components of charge (current×time) on the quality of Ni-64 deposits was investigated using the 500 mA deposition conditions from Example 6 as a baseline. As shown in earlier depletion studies (e.g., FIG. 7), increasing current accelerates Ni-64 depletion, while decreasing current slows the rate of deposition. In contrast, plating time behaves primarily as a response variable in full-depletion systems, since deposition must proceed for at least the minimum time required to achieve >99% Ni-64 removal. Once near-complete depletion is reached, additional deposition time adds charge to the system but no longer contributes meaningful nickel deposition, instead promoting electrolytic splitting of water into hydrogen and oxygen gas at the electrodes. Accordingly, a series of experiments was performed to investigate whether such an additional charge affects Ni-64 deposit quality.

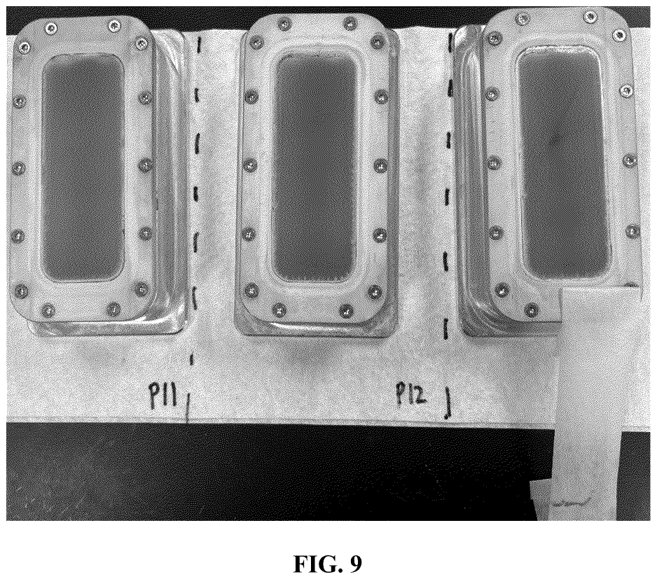

To evaluate temporal effects, Ni-64 targets plated at 500 mA were compared at two different removal times: (1) the approximate point at which >99% Ni-64 depletion occurs (˜120 minutes), and (2) a significantly extended plating duration (240 minutes) under the same conditions. The plates that were produced from this 120-minute experiment are shown below in FIG. 9. These 120-minute targets closely resemble the 240-minute targets in terms of color and adhesion. The 120-minute deposition did show some Ni peeling from the surface, but the location of this is at the top of the plate, and it is thought that this area peeling is not due to the time change between experiments but rather the design of the cell itself. The conclusion that can be made from this is that electrolysis does not significantly change the quality of already deposited Ni, and it is safe to add charge past the point of >99% Ni removal from solution for at least 120 minutes at 500 mA.

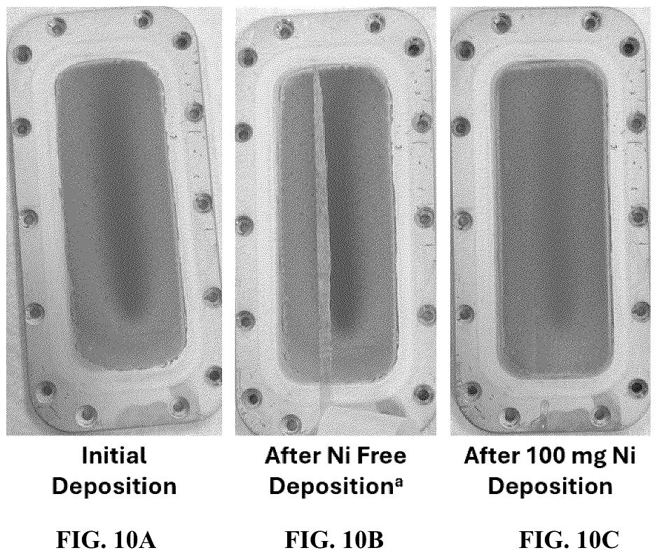

Further evidence supporting the time-insensitivity of deposit quality was obtained from a prior single-target experiment in which an already well-plated Ni target was placed into a plating bath containing no Ni-64, and a current of 1000 mA was applied for 120 minutes. As shown in FIGS. 10A-10C, no changes in deposit color or adhesion were observed, confirming that electrolysis alone does not damage an existing Ni layer. However, when 100 mg of Ni was added to the bath as NiCl₂ and plated at 1000 mA for 60 minutes, the resulting deposit darkened significantly (also shown in FIGS. 10A-C), demonstrating that darkened deposits arise during Ni deposition at high current, not during post-depletion electrolysis.

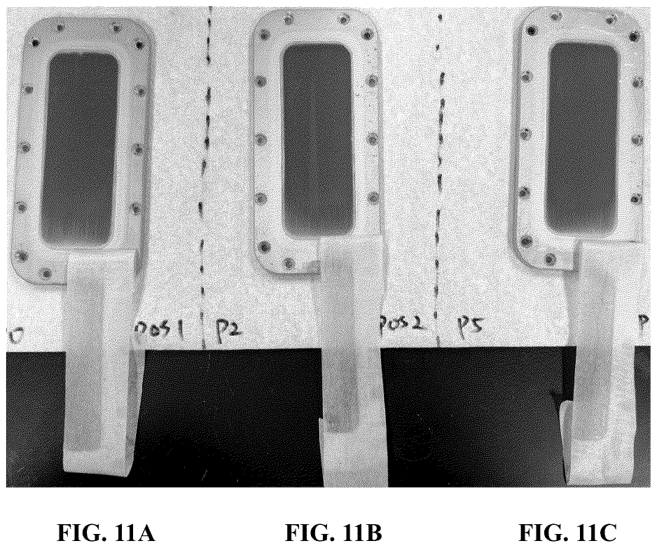

With time confirmed to be non-determinative of deposit quality, the effect of elevated current levels was next examined. A plating bath containing 750 mg of Ni-64 per target was deposited at 1500 mA, using otherwise identical conditions to the 500 mA baseline. As expected from depletion kinetics, >99% Ni-64 removal occurred within approximately 45 minutes, more than 100 minutes faster than under 500 mA conditions. However, as shown in FIG. 11, the deposits were extremely dark, powdery, and exhibited significant Ni removal in tape adhesion testing. These results confirm that although higher currents accelerate depletion, they also produce inferior deposit quality, characterized by oxide formation and poor adhesion.

Collectively, these experiments demonstrate that current, not time, is the principal determinant of Ni-64 deposit quality. Lower currents produce lighter, more adherent deposits but require longer deposition times, whereas higher currents deposit rapidly but yield degraded deposits. Additional plating time beyond full depletion does not adversely affect the appearance or integrity of the deposited Ni-64 layer.

The effect of Ni-64 concentration on the color, uniformity, and adhesion of deposited Ni-64 layers was evaluated using the Tri-Target Cell under controlled current conditions. Baths were prepared to contain different initial Ni-64 masses corresponding to 750 mg, 650 mg, 550 mg, and 400 mg Ni-64 per target, with all other bath constituents held constant. Depositions were performed according to the parameters shown in Table 5 and Table 11.

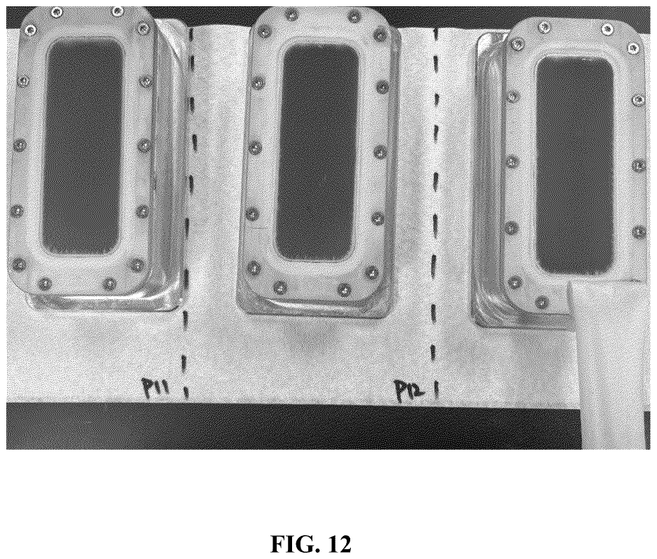

An initial experiment explored the plating behavior at the lowest Ni-64 concentration studied, 400 mg per target, using a current of 500 mA. As shown in FIG. 12, this condition produced a dark, blackened deposit with poor visual characteristics, although the deposit remained adherent under tape testing. The darkening was attributed to increased formation of nickel oxide species under conditions of insufficient Ni-64 concentration relative to the applied current.

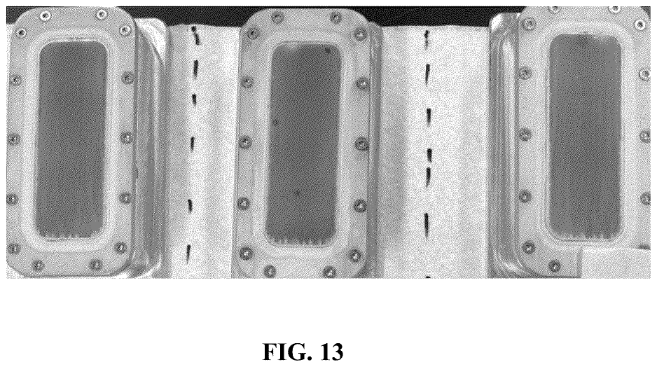

Based on this observation, the deposition current was reduced to 200 mA while maintaining the same 400 mg Ni-64 concentration. As illustrated in FIG. 13, deposition at 200 mA for approximately 180 minutes produced a uniform gray deposit with improved color and adhesion comparable to deposits obtained at higher Ni-64 concentrations. These results confirmed that lower Ni-64 concentrations require proportionally lower deposition currents to prevent oxide formation and achieve desirable deposit quality.

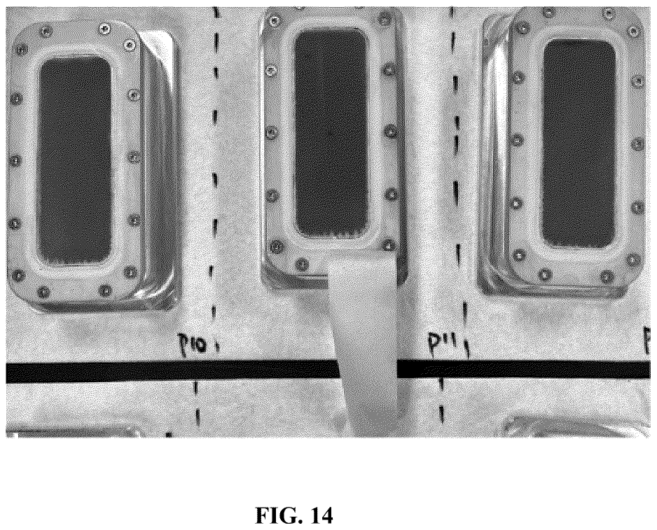

To further assess the role of deposition time, a follow-up experiment plated the same 400 mg Ni-64 bath at 500 mA, but with the deposition time reduced to 75 minutes instead of 120 minutes. As shown in FIG. 14, the resulting deposits were nearly identical to those produced at the full 120-minute duration, demonstrating again that time is not a controlling parameter for quality once optimal concentration-current relationships are satisfied and the bath reaches near-complete Ni-64 depletion.

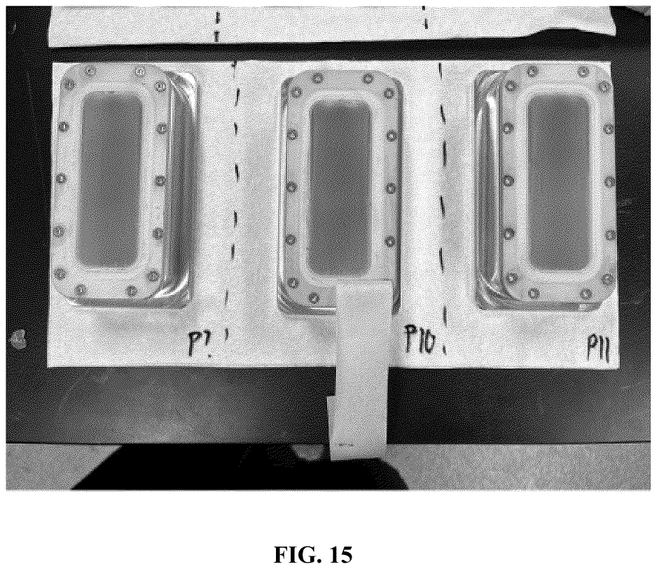

Finally, to validate the trend that lower currents improve deposit uniformity at lower Ni concentrations, a verification experiment was performed using 750 mg Ni-64 per target, plated at 200 mA for 300 minutes. The resulting deposits, represented in FIG. 15, exhibited the same light gray appearance and strong adhesion observed in 500 mA depositions at the same Ni-64 concentration. This confirmed that lower currents are capable of producing high-quality deposits at any concentration, albeit with longer plating times.

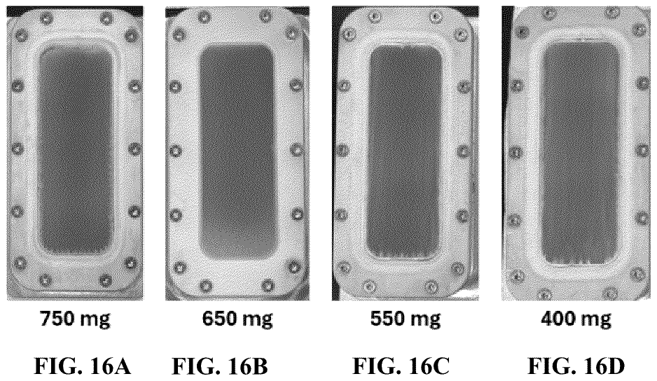

Taken together, these findings demonstrate a consistent and non-linear relationship between Ni-64 mass, plating current, and deposit quality. Lower Ni-64 concentrations require lower deposition currents to prevent oxidation and produce uniform, adherent deposits, while higher concentrations tolerate or benefit from higher current. These behaviors are captured visually in FIGS. 12-15 and mapped to corresponding operational parameters in Table 5 and FIGS. 16A-16D.

TABLE 5
Optimal plating parameters for depositing 400-
750 mg Ni from a triple target deposition bath.

| Targeted Ni Mass | Ni Bath Concentration | Current | Time |
|---|---|---|---|
| (g) | (mg/mL) | (mA) | (min) |
| 750 | 25 | 500 | 120-150 |
| 650 | 21.7 | 500 | 120 |
| 550 | 18.3 | 250 | 180 |
| 400 | 13.3 | 200 | 200 |

It was unexpectedly discovered that deposition time does not significantly influence the quality of the deposited Ni-64 layer once near-complete depletion is reached. Instead, deposit quality is governed predominantly by the applied current relative to Ni-64 concentration, contrary to conventional electroplating assumptions.

### Example 8: Plating Parameters for Varying Ni Concentrations (Tri-Target)

Using the experimentally established relationships between Ni-64 concentration, electrodeposition current, and plating time, a set of optimal deposition parameters was developed for producing high-quality Ni-64 deposits across a range of target masses from 400 mg to 750 mg per plate. Four target mass levels were evaluated, 750 mg, 650 mg, 550 mg, and 400 mg, and the corresponding optimal plating parameters are summarized in Table 5. Representative plated targets for each mass level are shown in FIG. 16, which illustrates the uniform gray appearance and strong adhesion achievable when the appropriate concentration-current pairing is used.

As shown in Table 5, high-quality deposits were achieved at 750 mg Ni-64 using a bath concentration of 25 mg/mL and a current of 500 mA for 120-150 minutes. Reducing the Ni-64 mass to 650 mg required no change in current, and plating at 500 mA for 120 minutes produced targets visually indistinguishable from the 750 mg condition, confirming that the 500 mA current remained appropriate at this concentration.

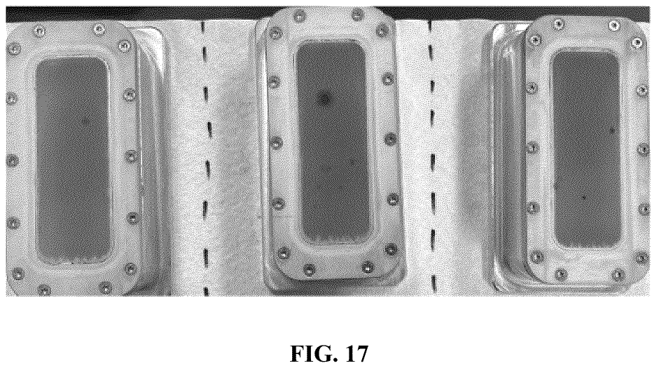

More significant parameter adjustments were required when the Ni-64 mass was reduced to 550 mg per target (18.3 mg/mL). Initial attempts to linearly scale the current from 500 mA to approximately 350 mA resulted in darker deposits, as shown in FIG. 17, indicating that the current remained too high for the reduced Ni-64 concentration. Through iterative refinement, it was determined that plating at 250 mA for 180 minutes restored the desirable light gray color and strong adhesion, establishing 250 mA as the optimal current for this concentration.

A similar optimization process was applied for the lowest Ni-64 mass evaluated, 400 mg per target (13.3 mg/mL). Initial deposition attempts at currents near 350 mA again produced darker, oxide-rich deposits. Reducing the current further to 200 mA, and extending the deposition time to approximately 200 minutes, yielded high-quality deposits comparable to those obtained at higher Ni-64 masses.

These studies demonstrate that optimal deposition quality requires selecting the electrodeposition current based on the initial Ni-64 concentration, rather than using a fixed current across all mass ranges. Lower Ni-64 concentrations require proportionally lower currents to suppress oxide formation and maintain uniform, adherent deposits, while higher concentrations support higher currents without quality degradation. The resulting concentration-current-time combinations shown in Table 5 and depicted in FIGS. 16 and 17 provide the operational framework for consistent full-depletion Ni-64 electrodeposition across the 400-750 mg mass range.

### Example 9: Plating Parameters for Varying Ni Concentrations (Single Target—“Flip Cell”)

As described in Example 5, single-target deposition using the Tri-Target Cell generally produced lower-quality Ni-64 deposits compared to multi-target operation. To evaluate whether single-target deposition quality could be improved, electrodeposition experiments were performed using the TR-30 Target MP Cell, also referred to as the “Flip Cell.” Unlike the Tri-Target Cell, which requires a minimum fill volume of approximately 90 mL to fully cover the deposition surface, the Flip Cell is designed such that the plating solution rests directly on top of the target. This geometry allows deposition to be carried out over a significantly broader range of plating bath volumes, typically 20-90 mL, thereby enabling adjustment of bath molarity to match that used in the optimized three-target processes.

To emulate the concentration conditions of the Tri-Target Cell, the plating bath volume for single-target deposition was reduced from 90 mL to 30 mL, increasing the Ni-64 molarity accordingly. The boric acid concentration was maintained at 30 mg/mL, and the quantity of ammonium hydroxide was adjusted to remain within the pH range previously identified as optimal. Using these modified bath volumes and concentrations, electrodeposition experiments were carried out under the same current and time parameters listed in Table 5 for the corresponding Ni-64 mass ranges.

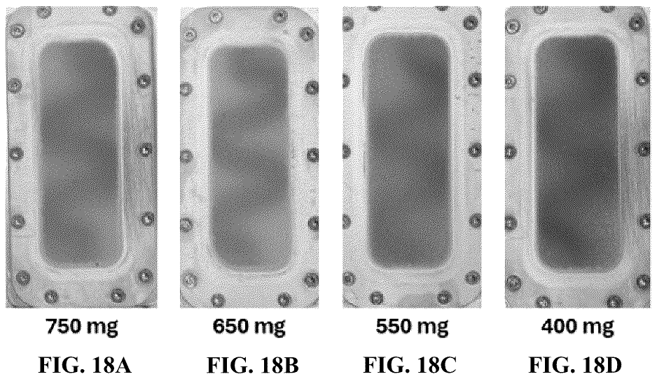

Representative results from these depositions are shown in FIGS. 18A-18D. FIGS. 18A-18D illustrate Flip Cell deposits for multiple Ni-64 mass targets. All deposits demonstrated uniform coloration and strong adhesion; none exhibited Ni removal during tape-based adhesion testing. Although a darkened “squiggle” was observed on the surfaces of several plates, this feature was attributed to localized NiO/Ni₂O₃ formation near the coiled platinum anode, which rests close to the plating surface. During electrodeposition, oxygen evolution at the anode can create localized regions of elevated oxygen concentration, promoting oxide formation in these areas. This effect was limited and did not compromise deposit uniformity or adhesion across the remainder of the surface.

Importantly, each deposition conducted in the Flip Cell achieved greater than 99% Ni-64 depletion from solution, confirming that full-depletion plating can be successfully achieved in the single-target configuration. These results demonstrate that, although single-target operation is less efficient for production-scale plating, the Flip Cell provides a viable and effective platform for research-scale Ni-64 electrodeposition, producing deposits comparable in quality to those obtained using the Tri-Target Cell when bath molarity and current are appropriately controlled.

### Example 10: Effect of Plating Bath Volume and Ni-64 Molarity on Deposit Quality in the Flip Cell

The Flip Cell enables electrodeposition over a wide range of plating bath volumes, allowing systematic evaluation of how Ni-64 molarity influences the quality of deposited Ni-64 layers. To investigate the effect of bath volume on deposit uniformity and appearance, an experiment was conducted in which the plating bath volume for a 750 mg Ni-64 per target deposition was increased from the optimized 30 mL (Example 8) to 60 mL, while maintaining identical bath composition ratios and plating conditions.

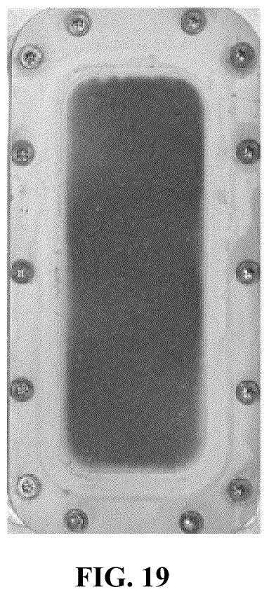

At the increased volume of 60 mL, the molarity of Ni-64 in solution was effectively halved relative to the standard 30 mL condition. Electrodeposition was performed at 500 mA, and the resulting deposit is shown in FIG. 19. Compared to the deposit formed at 30 mL, the 60 mL plating bath produced a darker and noticeably rougher surface, indicating reduced deposit quality and increased oxide formation attributable to the lower Ni-64 concentration.

Tape-based adhesion testing revealed that, despite the degraded appearance, no Ni-64 was removed from the surface, demonstrating that adhesion remained acceptable under these conditions. Nonetheless, the visual and textural differences between the two depositions confirm that lower bath volumes, and thus higher Ni-64 molarity, produce superior deposit quality in the Flip Cell configuration.

Collectively, these results illustrate that plating bath volume serves as a critical control parameter in single-target electrodeposition, with elevated molarity (achieved through reduced bath volume) leading to improved color, uniformity, and surface characteristics of Ni-64 deposits.

### Example 11: Ni-64 Plating Run 1-Run 250806 Ni-64 Plating

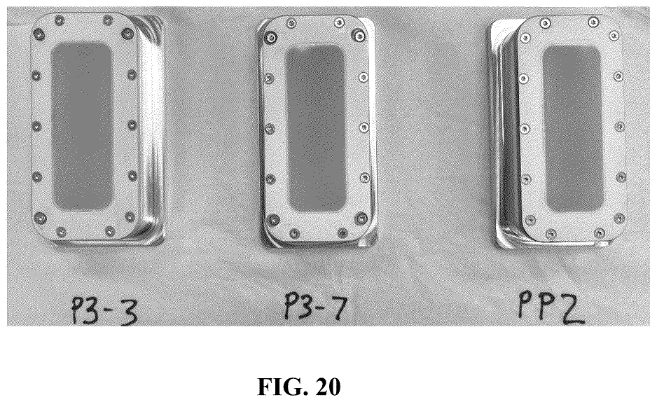

A total of 0.165 g of virgin enriched Ni-64 (99% purity) and 1.635 g of recovered Ni-64 material obtained from previous runs were combined to prepare the plating solution for three targets intended for subsequent irradiation. The targets were electrodeposited under constant-current conditions for 4 hours at 250 mA. All plated targets demonstrated acceptable appearance and adhesion upon inspection. Table 6 lists the target identifiers and corresponding plated masses. A representative photograph of the Ni-64 plated targets is provided in FIG. 20.

TABLE 6
Plated Target IDs and Masses

| Target ID | Plated Mass (mg) |
|---|---|
| 17JUL25-P3-3 | 624 |
| 17JUL25-P3-7 | 661 |
| 17JUL25-PP2 | 650 |

### Example 12: Ni-64 Plating Run 2-Run 250806 Ni-64 Plating

Recovered enriched Ni-64 from target (580 mg, 95% recovery) and 195 mg of Ni-64 remaining from the plating solution were combined to prepare a plating bath for a single target intended for irradiation. Electrodeposition was performed under constant-current conditions for 3 hours at 500 mA. Following deposition, the plated target exhibited acceptable surface appearance and adhesion, with no visible defects observed during handling or inspection.

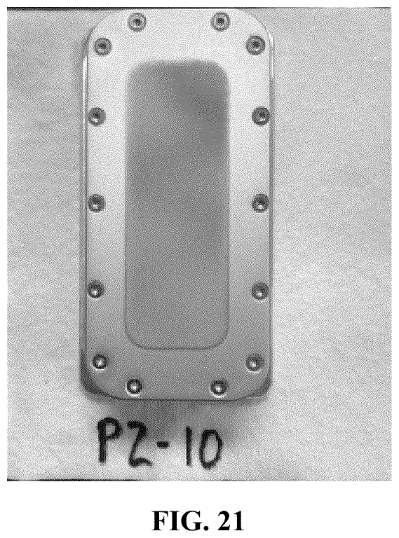

Table 7 lists the plated target identifier and the final plated mass. A representative photograph of the Ni-64 plated target is provided in FIG. 21.

TABLE 7
21Apr25 Plated Target ID and Mass

| Target ID | Plated Mass (mg) |
|---|---|
| 21Apr25-P2-10 | 770 |

### Example 13: Ni-64 Plating Run 3-Run 250820 Ni-64 Plating

A total of 0.2808 g of virgin enriched Ni-64 (99% purity) and 1.522 g of recovered Ni-64 material collected from runs were combined to prepare the plating bath for three targets intended for irradiation. Electrodeposition was performed at a constant current of 250 mA for 4 hours. All plated targets exhibited acceptable appearance and adhesion upon inspection, with no visible defects or areas of delamination.

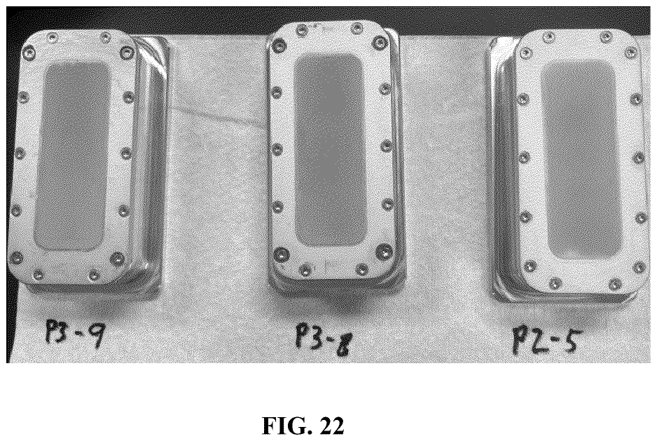

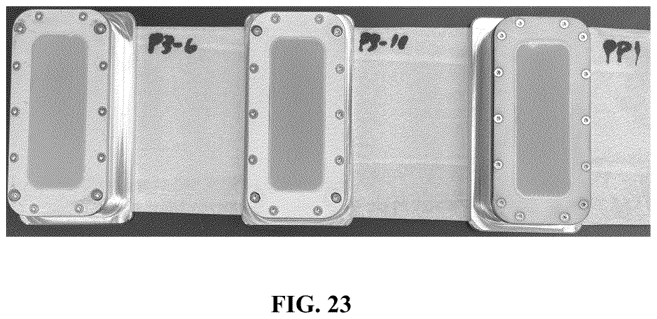

Table 8 lists the target identifiers and corresponding plated masses. A representative photograph of the three Ni-64 plated targets is provided in FIG. 22.

TABLE 8
19JUN25 Plated Target ID and Mass

| Target ID | Plated Mass (mg) |
|---|---|
| 19JUN25-P3-9 | 616 |
| 19JUN25-P3-8 | 614 |
| 19JUN25-P2-5 | 643 |

### Example 14: Ni-64 Plating Run 4-Run 250903 Ni-64 Plating

A total of 0.1811 g of virgin enriched nickel-64 (Ni-64) (Code G00016, Lot 234152, 99% purity) and 1.6241 g of recovered Ni-64 material obtained from Runs 250716-2.1L, 250806, and 250716-1.1R were combined to prepare the plating bath for three targets intended for irradiation. Electrodeposition was performed under constant-current conditions at 250 mA for 4 hours. All plated targets exhibited acceptable appearance and adhesion, with no cracking, flaking, or delamination observed during post-plating inspection.

Table 9 lists the plated target identifiers and corresponding plated masses.

TABLE 9
28Aug25 Plated Target ID and Mass

| Target ID | Plated Mass (mg) |
|---|---|
| 28Aug25-P3-6 | 687 |
| 28Aug25-P3-10 | 678 |
| 28Aug25-PP1 | 681 |

A summary of all Ni-64 target plating performed for Cu-64 development batches is provided in Table 10. For each batch, plated mass was expected to fall within ±50 mg of the calculated target value, derived from either the virgin Ni-64 mass alone or a combination of virgin and recovered Ni-64 quantified using ICP-OES data. In addition, plated targets were expected to display a smooth and uniform surface finish with no evidence of flaking, powdery deposits, or other adhesion defects. All plated targets met these expectations, achieving masses within the specified tolerance and exhibiting acceptable appearance and adhesion.

TABLE 10
Target Plating Summary

| | | Expected | Actual | |
|---|---|---|---|---|
| | | Plated | Plated | |
| | Associated | Mass | Mass | Plated Target |
| Target ID | Run | (mg) | (mg) | Appearance |
| 17Jul25-PP2 | 250806 | 648 | 650 | Smooth, even finish |
| | | | | with no flaking |
| | | | | (FIG. 20) |
| 21Apr25-P2- | 250813 | 736 | 770 | Smooth, even finish |
| 10 | | | | with no flaking |
| | | | | (FIG. 20) |
| 19Jun25-P2-5 | 250820 | 645 | 643 | Smooth, even finish |
| | | | | with no flaking |
| | | | | (FIG. 21) |
| 17Jul25-P3-3 | 250827- | 648 | 624 | Smooth, even finish |
| | 2.1 | | | with no flaking |
| | | | | (FIG. 20) |
| 17Jul25-P3-7 | 250827- | 648 | 661 | Smooth, even finish |
| | 1.1 | | | with no flaking |
| | | | | (FIG. 20) |
| 28Aug25-P3-6 | 250903 | 650 | 687 | Smooth, even finish |
| | | | | with no flaking |
| | | | | (FIG. 20) |

Before the present compositions, articles, devices, and/or methods are disclosed and described, it is to be understood that the aspects described below are not limited to specific methods as such may, of course, vary. It is also to be understood that the terminology used herein is for the purpose of describing particular aspects only and is not intended to be limiting.
Statement 1: A method of electrodepositing nickel-64 (Ni-64) onto one or more targets, the method comprising: preparing a Ni-64 plating bath with an initial Ni-64 concentration selected based on a targeted plated mass of Ni-64; introducing the Ni-64 plating bath to a electroplating cell comprising the one or more target and an anode; electrodepositing Ni-64 onto the one or more targets to form one or more plated targets until at least 99% of the initial Ni-64 concentration of the plating bath is depleted; and removing the one or more plated targets from the electroplating cell.
Statement 2: The method of statement 1, wherein the one or more plated targets are subsequently bombarded to produce ⁶⁴Cu and ⁶¹Co radionuclides acceptable for use in positron-emission tomography (PET) for a human patient in need thereof.
Statement 3: The method of statement 1, further comprising performing an adhesion test on a plated surface of the one or more plated targets by applying and removing a tape from the plated surface, wherein plated surface exhibits no visible removal of deposited Ni-64 during the adhesion test.
Statement 4: The method of statement 1, wherein the electroplating cell is configured to hold a single target, a double target, or a triple target.
Statement 5: The method of statement 4, wherein the electroplating cell is the triple-target assembly.
Statement 6: The method of statement 4, wherein depositing Ni-64 onto the triple-target assembly simultaneously produces improved deposit uniformity and reduced Ni-64 remaining in solution relative to the single target and the double-target assembly.
Statement 7: The method of statement 1, wherein electrodepositing Ni-64 is performed until at least 99.1% of the initial Ni-64 concentration of the plating bath is depleted.
Statement 8: The method of statement 1, wherein electrodepositing Ni-64 is performed until at least 99.2% of the initial Ni-64 concentration of the plating bath is depleted.
Statement 9: The method of statement 1, wherein electrodepositing Ni-64 is performed until at least 99.3% of the initial Ni-64 concentration of the plating bath is depleted.
Statement 10: The method of statement 1, wherein electrodepositing Ni-64 is performed until at least 99.4% of the initial Ni-64 concentration of the plating bath is depleted.
Statement 11: The method of statement 1, wherein electrodepositing Ni-64 is performed until at least 99.5% of the initial Ni-64 concentration of the plating bath is depleted.
Statement 12: The method of statement 1, wherein electrodepositing Ni-64 is performed until at least 99.6% of the initial Ni-64 concentration of the plating bath is depleted.
Statement 13: The method of statement 1, wherein electrodepositing Ni-64 is performed until at least 99.7% of the initial Ni-64 concentration of the plating bath is depleted.
Statement 14: The method of statement 1, wherein electrodepositing Ni-64 is performed until at least 99.8% of the initial Ni-64 concentration of the plating bath is depleted.
Statement 15: The method of statement 1, wherein electrodepositing Ni-64 is performed until at least 99.9% of the initial Ni-64 concentration of the plating bath is depleted.
Statement 16: The method of statement 1, wherein electrodepositing Ni-64 is performed until at least 99.95% of the initial Ni-64 concentration of the plating bath is depleted.
Statement 17: The method of statement 1, wherein electrodepositing Ni-64 is performed until at least 99.99% of the initial Ni-64 concentration of the plating bath is depleted.
Statement 18: The method of statement 1, wherein electrodepositing Ni-64 is performed using a current of about 200 mA to about 500 mA for a duration of about 60 minutes to about 420 minutes.
Statement 19: The method of statement 1, wherein electrodepositing Ni-64 is performed for a duration of about 60 minutes to about 120 minutes.
Statement 20: The method of statement 1, wherein electrodepositing Ni-64 is performed for a duration of about 120 minutes to about 150 minutes.
Statement 21: The method of statement 1, wherein electrodepositing Ni-64 is performed for a duration of about 120 minutes to about 180 minutes.
Statement 22: The method of statement 1, wherein electrodepositing Ni-64 is performed for a duration of about 180 minutes to about 240 minutes.
Statement 23: The method of statement 1, wherein electrodepositing Ni-64 is performed for a duration of about 240 minutes to about 300 minutes.
Statement 24: The method of statement 1, wherein electrodepositing Ni-64 is performed for about 300 minutes to about 360 minutes.
Statement 25: The method of statement 1, wherein electrodepositing Ni-64 is performed for a duration of about 360 minutes to about 420 minutes.
Statement 26: The method of statement 1, wherein electrodepositing Ni-64 is performed for a duration of about 220 minutes to about 240 minutes.
Statement 27: The method of statement 1, wherein electrodepositing Ni-64 is performed for a duration of about 380 minutes to about 400 minutes.
Statement 28: The method of statement 1, wherein electrodepositing Ni-64 is performed using a current of about 200 mA to about 500 mA.
Statement 29: The method of statement 1, wherein electrodepositing Ni-64 is performed using a current of about 200 mA to about 250 mA.
Statement 30: The method of statement 1, wherein electrodepositing Ni-64 is performed using a current of about 250 mA to about 300 mA.
Statement 31: The method of statement 1, wherein electrodepositing Ni-64 is performed using a current of about 300 mA to about 350 mA.
Statement 32: The method of statement 1, wherein electrodepositing Ni-64 is performed using a current of about 350 mA to about 400 mA.
Statement 33: The method of statement 1, wherein electrodepositing Ni-64 is performed using a current of about 400 mA to about 450 mA.
Statement 34: The method of statement 1, wherein electrodepositing Ni-64 is performed using a current of about 450 mA to about 500 mA.
Statement 35: The method of statement 1, wherein the targeted plated mass of Ni-64 is between about 400 mg to about 800 mg per target plate.
Statement 36: The method of statement 35, wherein the targeted plated mass of Ni-64 is between about 400 mg to about 450 mg per target plate.
Statement 37: The method of statement 35, wherein the targeted plated mass of Ni-64 is between about 450 mg to about 500 mg per target plate.
Statement 38: The method of statement 35, wherein the targeted plated mass of Ni-64 is between about 500 mg to about 550 mg per target plate.
Statement 39: The method of statement 35, wherein the targeted plated mass of Ni-64 is between about 550 mg to about 600 mg per target plate.
Statement 40: The method of statement 35, wherein the targeted plated mass of Ni-64 is between about 600 mg to about 650 mg per target plate.
Statement 41: The method of statement 35, wherein the targeted plated mass of Ni-64 is between about 650 mg to about 700 mg per target plate.
Statement 42: The method of statement 35, wherein the targeted plated mass of Ni-64 is between about 700 mg to about 750 mg per target plate.
Statement 43: The method of statement 35, wherein the targeted plated mass of Ni-64 is between about 750 mg to about 800 mg per target plate.
Statement 44: The method of statement 1, wherein the Ni-64 plating bath comprises recycled Ni-64, virgin Ni-64, or both.
Statement 45: The method of statement 44, wherein the recycled Ni-64 is recovered from a previous Ni-64 recovery process.
Statement 46: The method of statement 1, wherein the Ni-64 plating bath comprises Ni-64, boric acid, ammonium hydroxide, and water.
Statement 47: The method of statement 46, wherein amount of Ni-64 is from about 1300 mg to about 2500 mg.
Statement 48: The method of statement 46, wherein amount of boric acid is from about 0.01 mg to about 5 g.
Statement 49: The method of statement 46, wherein amount of ammonium hydroxide is from about 25 mL to about 35 mL.
Statement 50: The method of statement 46, wherein amount of water is from about 80 mL to about 100 mL.
Statement 51: The method of statement 1, wherein the initial Ni-64 concentration in the Ni-64 plating bath is from about 10 mg/mL to about 40 mg/mL.
Statement 52: The method of statement 1, wherein the initial Ni-64 concentration in the Ni-64 plating bath is from about 10 mg/mL to about 12 mg/mL.
Statement 53: The method of statement 1, wherein the initial Ni-64 concentration in the Ni-64 plating bath is from about 12 mg/mL to about 14 mg/mL.
Statement 54: The method of statement 1, wherein the initial Ni-64 concentration in the Ni-64 plating bath is from about 14 mg/mL to about 16 mg/mL.
Statement 55: The method of statement 1, wherein the initial Ni-64 concentration in the Ni-64 plating bath is from about 16 mg/mL to about 18 mg/mL.
Statement 56: The method of statement 1, wherein the initial Ni-64 concentration in the Ni-64 plating bath is from about 18 mg/mL to about 20 mg/mL.
Statement 57: The method of statement 1, wherein the initial Ni-64 concentration in the Ni-64 plating bath is from about 20 mg/mL to about 22 mg/mL.
Statement 58: The method of statement 1, wherein the initial Ni-64 concentration in the Ni-64 plating bath is from about 22 mg/mL to about 24 mg/mL.
Statement 59: The method of statement 1, wherein the initial Ni-64 concentration in the Ni-64 plating bath is from about 24 mg/mL to about 26 mg/mL.
Statement 60: The method of statement 1, wherein the initial Ni-64 concentration in the Ni-64 plating bath is from about 26 mg/mL to about 28 mg/mL.
Statement 61: The method of statement 1, wherein the initial Ni-64 concentration in the Ni-64 plating bath is from about 28 mg/mL to about 30 mg/mL.
Statement 62: The method of statement 1, wherein the initial Ni-64 concentration in the Ni-64 plating bath is from about 30 mg/mL to about 32 mg/mL.
Statement 63: The method of statement 1, wherein the initial Ni-64 concentration in the Ni-64 plating bath is from about 32 mg/mL to about 34 mg/mL.
Statement 64: The method of statement 1, wherein the initial Ni-64 concentration in the Ni-64 plating bath is from about 34 mg/mL to about 36 mg/mL.
Statement 65: The method of statement 1, wherein the initial Ni-64 concentration in the Ni-64 plating bath is from about 36 mg/mL to about 38 mg/mL.
Statement 66: The method of statement 1, wherein the initial Ni-64 concentration in the Ni-64 plating bath is from about 38 mg/mL to about 40 mg/mL.
Statement 67: The method of statement 1, wherein preparing a Ni-64 plating bath comprises: preparing a Ni-64 chloride solution by dissolving solid Ni-64 chloride in water to form the Ni-64 chloride solution; removing water from the Ni-64 chloride solution to form a dry Ni-64 chloride solid; and adding boric acid, ammonium hydroxide, and water to the dry Ni-64 and chloride solid forming the Ni-64 plating bath.
Statement 68: The method of statement 1, wherein electrodepositing Ni-64 is performed using a current selected based on the initial Ni-64 concentration, wherein a lower Ni-64 concentration corresponds to lower current and a higher Ni-64 concentration correspond to higher current.
Statement 69: The method of statement 68, wherein the current maintains a light-colored, adherent Ni-64 deposit and suppresses formation of nickel oxide or nickel (III) oxide.
Statement 70: The method of statement 1, wherein deposition parameters are selected to achieve depletion of at least 99% of the initial Ni-64 concentration of the plating bath and to produce a uniform, adherent Ni-64 layer on the one or more targets.
Statement 71: A method for electrodepositing nickel-64 (Ni-64) onto one or more targets, the method comprising: configuring an electroplating cell with one or more targets; adding water to the electroplating cell; performing a leak test to ensure electroplating cell is not leaking; removing water from the electroplating cell; adding an acid solution and anode to the electroplating cell; soaking the electroplating cell with the acid solution for at least 15 minutes; removing the acid solution from the electroplating cell; rinsing the electroplating cell with water and drying the electroplating cell; adding a plating bath with an initial Ni-64 concentration to the electroplating cell; electrodepositing Ni-64 onto the one or more targets until at least 99% of the initial Ni-64 concentration of the plating bath is depleted; removing a portion of the plating solution from the electroplating cell; measuring Ni-64 concentration in the plating bath; electrodepositing Ni-64 onto the one or more targets until at least 99% of the initial Ni-64 concentration of the plating bath is depleted; removing the plating bath from the electroplating cell; and removing and drying the one or more targets from the electroplating cell.
Statement 72: The method of statement 71, wherein the acid solution is an inorganic acid selected from the group consisting of nitric acid, hydrochloric acid, sulfuric acid, and phosphoric acid.
Statement 73: An electrodeposited plate comprising a Ni-64 plated plate, wherein the electrodeposited plate is made according to statement 1.
Statement 74: The electrodeposited plate of statement 73, wherein the plate has a plated surface with no visible removal of deposited Ni-64 after an adhesion test.
Statement 75: The electrodeposited plate of statement 73, wherein the plate is subsequently bombarded to produce ⁶⁴Cu and ⁶¹Co radionuclides for use in positron-emission tomography (PET).
Statement 76: The electrodeposited plate of statement 73, wherein the plate has a uniform and adherent Ni-64 layer.
Statement 77: The electrodeposited plate of statement 73, wherein the Ni-64 plated plate has a uniform gray appearance and absence of flaking under adhesion testing.

What is claimed is:

1. A method of electrodepositing nickel-64 (Ni-64) onto one or more targets, the method comprising:
preparing a Ni-64 plating bath with an initial Ni-64 concentration selected based on a targeted plated mass of Ni-64;
introducing the Ni-64 plating bath to an electroplating cell comprising the one or more target and an anode;
electrodepositing Ni-64 onto the one or more targets to form one or more plated targets until at least 99% of the initial Ni-64 concentration of the plating bath is depleted; and
removing the one or more plated targets from the electroplating cell.

2. The method of claim 1, wherein the one or more plated targets are subsequently bombarded to produce ⁶⁴Cu and ⁶¹Co radionuclides for use in positron-emission tomography (PET).

3. The method of claim 1, further comprising performing an adhesion test on a plated surface of the one or more plated targets by applying and removing a tape from the plated surface, wherein the plated surface exhibits no visible removal of deposited Ni-64 during the adhesion test.

4. The method of claim 1, wherein the electroplating cell is configured to hold a single target, a double target, or a triple target.

5. The method of claim 4, wherein the electroplating cell is the triple-target assembly.

6. The method of claim 4, wherein depositing Ni-64 onto the triple-target assembly simultaneously produces improved deposit uniformity and reduced Ni-64 remaining in solution relative to the single target and the double-target assembly.

7. The method of claim 1, wherein electrodepositing Ni-64 is performed until at least 99.5% of the initial Ni-64 concentration of the plating bath is depleted.

8. The method of claim 1, wherein electrodepositing Ni-64 is performed until at least 99.9% of the initial Ni-64 concentration of the plating bath is depleted.

9. The method of claim 1, wherein electrodepositing Ni-64 is performed until at least 99.95% of the initial Ni-64 concentration of the plating bath is depleted.

10. The method of claim 1, wherein electrodepositing Ni-64 is performed until at least 99.99% of the initial Ni-64 concentration of the plating bath is depleted.

11. The method of claim 1, wherein electrodepositing Ni-64 is performed using a current of about 200 mA to about 500 mA for a duration of about 60 minutes to about 420 minutes.

12. The method of claim 1, wherein electrodepositing Ni-64 is performed for a duration of about 60 minutes to about 120 minutes.

13. The method of claim 1, wherein electrodepositing Ni-64 is performed for a duration of about 120 minutes to about 150 minutes.

14. The method of claim 1, wherein electrodepositing Ni-64 is performed for a duration of about 120 minutes to about 180 minutes.

15. The method of claim 1, wherein electrodepositing Ni-64 is performed for a duration of about 180 minutes to about 240 minutes.

16. The method of claim 1, wherein electrodepositing Ni-64 is performed for a duration of about 240 minutes to about 300 minutes.

17. The method of claim 1, wherein electrodepositing Ni-64 is performed for about 300 minutes to about 360 minutes.

18. The method of claim 1, wherein electrodepositing Ni-64 is performed for a duration of about 360 minutes to about 420 minutes.

19. The method of claim 1, wherein electrodepositing Ni-64 is performed for a duration of about 220 minutes to about 240 minutes.

20. The method of claim 1, wherein electrodepositing Ni-64 is performed for a duration of about 380 minutes to about 400 minutes.

21. The method of claim 1, wherein electrodepositing Ni-64 is performed using a current of about 200 mA to about 500 mA.

22. The method of claim 1, wherein electrodepositing Ni-64 is performed using a current of about 200 mA to about 250 mA.

23. The method of claim 1, wherein electrodepositing Ni-64 is performed using a current of about 250 mA to about 300 mA.

24. The method of claim 1, wherein electrodepositing Ni-64 is performed using a current of about 300 mA to about 350 mA.

25. The method of claim 1, wherein electrodepositing Ni-64 is performed using a current of about 350 mA to about 400 mA.

26. The method of claim 1, wherein electrodepositing Ni-64 is performed using a current of about 400 mA to about 450 mA.

27. The method of claim 1, wherein electrodepositing Ni-64 is performed using a current of about 450 mA to about 500 mA.

28. The method of claim 1, wherein the targeted plated mass of Ni-64 is between about 400 mg to about 800 mg per target plate.
